(19) United States
(12) Patent Application Publication
(10) Pub. No.: US 2008/0040165 A1
(43) Pub. Date: Feb. 14, 2008

(54) Transgenic crop financial systems and methods

(75) Inventors: John R. Anderson, Raleigh, NC (US); John H. Jansen, St. Lous, MO (US); Harrison R. Hakes, Carmel, IN (US); Barry K. Goodwin, Cary, NC (US); Nicholas E. Piggott, Raleigh, NC (US); David J. Rhylander, Memphis, TN (US)

Correspondence Address: HOWREY LLP, C/O IP DOCKETING DEPARTMENT, 2941 FAIRVIEW PARK DRIVE SUITE 200, FALLS CHURCH, VA, 22042, US

(73) Assignee: Monsanto Technology LLC

(21) Appl. No.: 11/731,809

(22) Filed: Mar. 30, 2007

Related U.S. Application Data
(60) Provisional application No. 60/836,546, filed on Aug. 8, 2006.
(60) Provisional application No. 60/900,407, filed on Feb. 9, 2007.

(51) Int. Cl. G06Q 40/00

(52) U.S. Cl. 705/4

(57) ABSTRACT

The invention provides systems and methods for determining discounted rates for insurance on and financial products relating to transgenic traited crops as compared to their traditional, non-traited counterparts. Certain methods of the invention involve generating comparison data contrasting the yields of transgenic traited crops to their traditional non-traited counterparts. The distribution of the differences between the transgenic and traditional yields is measured. The degree of correlation between the transgenic yields and the differences between the transgenic and traditional yields is measured to create a novel method for assessing mitigation of abiotic and biotic stresses by transgenic crops. A probability distribution function is fit to a traditional rate structure, and a distribution for the transgenic crop yield is determined. The discounted premium rate is determined from the probability function, and a discount rate factor is determined.

### CROSS-REFERENCE TO RELATED APPLICATION

This application claims priority to pending provisional patent application Ser. No. 60/836,546, filed Aug. 8, 2006 and to pending provisional patent application Ser. No. 60/900,407, filed Feb. 8, 2007.

### BACKGROUND

Transgenic crops are comprised of plants that have been genetically-engineered to exhibit new characteristics. Recombinant DNA technology is used to add one or more new genes to a plant's genome in ways that allow the plant to express new characteristics called “traits.” Such traits include, for example, tolerance to certain herbicides containing glyphosate, a compound manufactured, formulated and sold by the Monsanto Company under the tradename Roundup®. Seeds of crops that have been genetically-modified to tolerate Roundup® are sold by Monsanto under the Roundup Ready® tradename. Other crop traits created via genetic modification convey drought tolerance, insect tolerance, efficient nitrogen use, cold tolerance, and heat tolerance. Transgenic traits may also alter the composition of crop plants in ways that increase oil production, protein production, fermentable starch production, and the concentration of valuable constituents like the essential amino acid lysine. Transgenic traits may also increase crop yield and stability. With respect to characteristics that have been modified, transgenic crop traits often provide dramatic performance improvements over conventional, non-traited crops. Crop performance and value can be enhanced further by combining or “stacking” multiple traits into crop plants.

In only a decade, transgenic crop traits have discontinuously transformed the way that corn, soybeans are cotton are produced. Since they were first commercialized by the Monsanto Company in 1996, transgenic crops have been adopted by farmers faster than any agricultural technology in history. Despite the fact that they are relatively new technologies, global, transgenic crop acreage in 2006 exceeded 250 million acres planted by 10.3 million farmers in 22 countries.

Crop insurance is a primary tool that agricultural businesses use to manage risks inherent to agricultural crop and livestock production. The United States Department of Agriculture's (USDA's) Risk Management Agency (RMA) regulates crop insurance policies offered to agricultural producers by private insurance companies. Currently, the RMA subsidizes policy premiums for farmers and ranchers; coverage is offered for more than 100 crop and livestock enterprises. RMA also conducts feasibility studies for new crop and livestock insurance products and innovations.

The RMA approves many types of crop insurance policies. Actual Production History (APH) insurance policies are yield-based policies that insure agricultural producers against decreased crop yields due to any number of natural causes including drought, flooding, frost, heat, disease, and pests. Producers may insure a percentage of their historical yields against loss at a specified price for that crop in a particular year. Coverage levels and pricing mechanisms are established by the RMA at the time the policy is purchased. For example, if producer insure 75% of their historical yields at 90% of RMA's predicted crop price in a year that harvest results in only 50% of the historical yield, then the producers are insured for 25% (i.e., 75% insured-50% actual yield) of the historical yield. The producers would receive an indemnity of 90% of the price of the insured 25%. APH policies may vary in how historical yields are determined. For example, some APH policies base historical yield on county averages rather than individual producers' historical yields. Other insurance policies provided by the RMA include revenue insurance plans, which make indemnity payments based on deviations from historic revenues for a crop. Revenue insurance plans can be based on historic revenues for a county, for an entire farm, or for individual crops.

Like most insurers, crop insurers employ actuaries who calculate a monetary value that corresponds to the risk of loss and they charge an insurance premium to the insured that reflects the calculated value. Currently, actuaries base their calculations on models that utilize data such as historical yields of crops grown in the same counties as the crop to be insured. While actuaries have actuarial models for crop yields in over 100 crops, no actuarial model is adjusted for risk associated with transgenic crops.

Most crop insurance policies are rated on decades of loss-cost experience and actuarial models adjust slowly to new information. The rapid emergence of genetic-engineering, its application to crop science, and the discontinuous impacts of current genetically-engineered traits on crop yield make accurate rating of APH-dependent crop insurance policies extraordinarily difficult. Moreover, continued improvements in biotechnology, in tandem with the discontinuous yield and trait improvements associated with future biotechnologies, will make traditional actuarial processes inadequate/inaccurate for mathematically describing and rating risks associated with transgenic crops. Because a growing number of crops are being genetically-improved and, because the acreage of transgenic crops is growing relative to all crops, there is a need in the art for methods and financial products that can properly evaluate, in shorter time frames, the risks associated with producing transgenic crops. Furthermore, swift development of new transgenic crops with new traits has created the possibility for new methods and financial products that consider features unique to transgenic crops.

### DESCRIPTIONS OF THE DRAWINGS

FIG. 1 is an image showing how Yield Guard® Plus with Roundup Ready® Corn 2 conveys stress tolerance that improves the yield of corn crops.

FIG. 2 is a remotely-sensed image documenting the stress tolerance and improved yield derived from transgenic crops, in the case the Monsanto Company's Yield Guard® Plus with Roundup Ready® Corn 2 product.

FIG. 3 is a chart showing that the transgenic “traited” crops, relative to non-transgenic “non-traited” crops, perform better when adverse growing conditions are encountered.

FIG. 4 is a chart showing how transgenic “traited” corn yield distributions, relative to non-transgenic “non-traited” corn yield distributions, reflect higher yields, less yield variance and yield stability.

FIG. 5 illustrates how transgenic corn bearing drought tolerance traits can thrive relative to conventional, non-transgenic corn.

FIG. 6 illustrates how transgenic cotton bearing drought tolerance traits can thrive relative to conventional, non-transgenic cotton.

FIG. 7 illustrates how transgenic corn can thrive under limited nitrogen regimes relative to conventional, non-transgenic corn.

FIG. 8 illustrates how transgenic corn can thrive under cold stress conditions relative to conventional, non-transgenic corn.

FIGS. 9A and 9B show the steps in one of the methods of the invention, and the systems of the invention on which the methods may be implemented.

FIGS. 10, 11, and 12 show the distributional properties of yield differences for rate classes 1, 2, and 3 respectively in the Example provided herein.

FIGS. 13, 14, and 15 show plots of fitted and actual discount factors for 50%, 75%, and 85% coverage levels respectively in the Example provided herein.

### SUMMARY

An objective of the invention is to provide methods and financial products that properly evaluate the risks associated with producing transgenic crops wherein the transgenic crop exhibits at least one trait as a result of having at least one transgene. Another objective of the invention is to provide methods that increase the rating accuracy or “actuarial soundness” of crop insurance, particularly as they relate to the impact of transgenic crops on risk associated with crop enterprises.

In one embodiment, the invention includes a method for calculating a rate for a transgenic crop insurance policy purchased by a crop producer, wherein the transgenic crop comprises at least one trait as a result of having at least one transgene, the method comprising the steps of: calculating a first risk premium associated with a conventional, non-transgenic crop based upon the actual production history yields of the conventional, non-transgenic crop; growing the transgenic crop and determining the yield of the transgenic crop to generate yield data for the transgenic crop; comparing the yield data for the transgenic crop to yield data for the conventional, non-transgenic crops to create a risk correlation based on (1) the difference between the yield data for the transgenic crop and the yield data for the conventional, non-transgenic crop, correlated with (2) the yield data for the non-transgenic crop; simulating a yield distribution for the difference in yield performance between the transgenic and the non-transgenic crop using the risk correlation; simulating a yield distribution for the conventional, non-transgenic crop using existing crop insurance rates; creating a yield distribution for the transgenic crop based on (a) the risk correlation, (b) the simulated yield distribution for the difference in yield distribution for the difference in yield performance between the transgenic and the non-transgenic crop, and (c) the yield distribution for the conventional, non-transgenic crop; and calculating the rate for the transgenic crop insurance policy based on the yield distribution for the transgenic crop.

In some embodiments, the invention further comprises one or more of the following steps: incorporating the rate for the transgenic crop insurance policy into a ratio with the rate for a conventional, non-transgenic crop insurance policy to produce a discount factor; applying the discount factor to the first risk premium to calculate a second risk premium for a transgenic crop; incorporating the discount factor into an existing RMA crop insurance rating system; using the risk correlation to measure an effectiveness of a transgenic trait, a non-transgenic crop trait, or a combination of transgenic and non-transgenic crop traits to mitigate abiotic or biotic stresses; determining the difference between the first risk premium and the second risk premium to produce a difference risk premium.

In some embodiments the steps of calculating the first and second risk premiums include measuring crop yield distributions and using crop analytics or remotely-sensing methodology to determine crop composition, predict yield, or estimate risk.

The transgenic crops in the present invention may have one or more traits including drought resistance, water logged soil tolerance, salt tolerance, disease resistance, herbicide tolerance, tolerance to herbicide-resistant weeds, insect resistance, efficient nitrogen use, cold stress tolerance, heat stress tolerance, increased oil production, increased protein production, unique oil and protein production, increased fermentable starch production, increased content of essential amino acids, increased content of fatty acids, increased yield, and yield stability. In some embodiments of the invention, the transgenic crop has two or more stacked traits. The transgenic crops in the present invention may include, but are not limited to, corn, soybean, cotton, rice, wheat, canola, vegetable crops, forest tree crops, forage crops, and cellulosic ethanol feedstocks.

In some embodiments of the invention, the crop producer purchases transgenic crop seeds for a price that is greater than the price of the conventional, non-transgenic crop seeds for the same crop by an amount that is equal to or greater than the difference risk premium. In some embodiments, the crop producer pays the difference risk premium for the transgenic crop seeds only if the risk management benefits of the trait are realized. In some embodiments, the crop producer purchases transgenic crop seeds for a price that includes a difference in the risk premium.

Certain embodiments of the invention include a financial instrument comprising a transgenic crop insurance policy, wherein the price of the transgenic crop insurance policy is reduced relative to a conventional non-transgenic crop insurance policy for the same type of crop by an amount corresponding to a value measured as the cost of the difference between: (a) a risk premium associated with a conventional, non-transgenic crop based upon the actual production history yields of the conventional, non-transgenic crop, and (b) a risk premium associated with a transgenic crop based upon measured yield distributions or the actual production history yields of the transgenic crop, wherein the transgenic crop exhibits at least one trait as a result of having at least one transgene. In some embodiments, the invention includes a production agreement for a transgenic crop wherein the production agreement is based upon a calculation of a risk premium associated with a transgenic crop based upon measured yield distributions, simulated yield distributions, or the actual production history yields of the transgenic crop.

In another embodiment, the invention includes a method for determining an insurance premium rate for a transgenic crop comprising the steps of: determining an expected yield for the transgenic crop; fitting a probability distribution function to a rating structure for a traditional crop using the expected yield; simulating a yield distribution for the transgenic crop; and estimating the premium rate for the transgenic crop based on the simulated yield distribution. Some embodiments include the step of gathering yield data from side-by-side field trials of the transgenic and traditional crops, and determining yield differences between the transgenic crop and the traditional crop from the yield data.

In some embodiments, the probability distribution function is a beta probability distribution function. In some embodiments, the step of simulating a yield distribution for the transgenic crop comprises drawing correlated random variables from the beta distribution for the rating structure for the traditional crop and an estimated distribution of the yield differences between the transgenic crop and the traditional crop.

### DETAILED DESCRIPTION

The inventions described here are systems and methods for developing and implementing financial instruments relating to transgenic crops, including crop insurance and production agreements. Certain embodiments of the invention involve calculating financial risk incurred by crop producers who plant transgenic crops. The inventions described here include using transgenic crop traits to reduce financial risk, evaluating the reduction in financial risk from transgenic crop traits, and using the financial risk evaluation in financial instruments by, for example, reducing the price of crop insurance premiums based on the reduced financial risk derived from transgenic crop traits.

Table 1 below lists examples of transgenic crop traits that have the potential to reduce risks associated with crop production, along with the genes or proteins responsible for each trait, and references to patents and applications that describe how to provide each trait.

TABLE 1
Examples of traits and related protein molecules that provide agronomic benefit
for reducing risk in crop production.

| Trait | Gene/protein | Reference |
|---|---|---|
| Herbicide | 5-enolpyruvylshikimate-3-phosphate | U.S. Pat. No. 5,627,061, |
| tolerance | synthases | U.S. Pat. No. 5,633,435, |
| | | U.S. Pat. No. 6,040,497, |
| | | U.S. Pat. No. 5,094,945, |
| | | US20060143727, |
| | | US20070004907, |
| | | US20060253921, |
| | | US20060150270, |
| | | US20050204436, |
| | | US20040177399, and |
| | | WO04009761 |
| | glyphosate oxidoreductase (GOX) | U.S. Pat. No. 5,463,175 |
| | glyphosate decarboxylase | WO05003362 and US |
| | | Patent Application |
| | | 20040177399 |
| | glyphosate-N-acetyl transferase (GAT) | U.S. Patent publication |
| | | 20030083480 |
| | dicamba monooxygenase | US Patent Applications |
| | | 20030115626, |
| | | 20030135879 |
| | phosphinothricin acetyltransferase (bar) | (U.S. Pat. No. 5,646,024, U.S. Pat. No. |
| | | 5,561,236, EP 275,957; |
| | | U.S. Pat. No. 5,276,268; U.S. Pat. No. |
| | | 5,637,489; U.S. Pat. No. |
| | | 5,273,894); |
| | 2,2-dichloropropionic acid | WO9927116 |
| | dehalogenase | |
| | acetohydroxyacid synthase or | U.S. Pat. No. 6225105; U.S. Pat. No. 5767366, |
| | acetolactate synthase | U.S. Pat. No. 4,761,373; U.S. Pat. No. |
| | | 5,633,437; U.S. Pat. No. |
| | | 6,613,963; U.S. Pat. No.5013659; |
| | | U.S. Pat. No.5141870; U.S. Pat. No.5378824; |
| | | U.S. Pat. No.5605011 |
| | haloarylnitrilase (Bxn) | U.S. Pat. No. 4,810,648 |
| | acetyl-coenzyme A carboxylase | U.S. Pat. No. 6,414,222 |
| | dihydropteroate synthase (sul I) | U.S. Pat. No.5597717; U.S. Pat. No.5633444; |
| | | U.S. Pat. No.5719046 |
| | 32 kD photosystem II polypeptide | Hirschberg et al., 1983, |
| | (psbA) | Science, 222:1346-1349 |
| | anthranilate synthase | U.S. Pat. No. 4,581,847 |
| | phytoene desaturase (crtI) | JP06343473 |
| | hydroxy-phenyl pyruvate dioxygenase | U.S. Pat. No.6268549 |
| | protoporphyrinogen oxidase I (protox) | U.S. Pat. No. 5,939,602 |
| | aryloxyalkanoate dioxygenase (AAD-1) | WO05107437 |
| Male/female | Several | US20050150013 |
| sterility system | Glyphosate/EPSPS | U.S. Pat. No. 6,762,344 |
| | Male sterility gene linked to herbicide | U.S. Pat. No. 6,646,186 |
| | resistant gene | |
| | Acetylated toxins/deacetylase | U.S. Pat. No. 6,384,304 |
| | Antisense to an essential gene in pollen | U.S. Pat. No. 6,255,564 |
| | formation | |
| | DNAase or endonuclease/restorer | U.S. Pat. No. 6,046,382 |
| | protein | |
| | Ribonuclease/barnase | U.S. Pat. No. 5,633,441 |
| Yield | glycolate oxidase or glycolate | US2006009598 |
| | dehydrogenase, glyoxylate carboligase, | |
| | tartronic semialdehyde reductase | |
| | eukaryotic initiation Factor 5A; | US20050235378 |
| | deoxyhypusine synthase | |
| | zinc finger protein | US20060048239 |
| | methionine aminopeptidase | US20060037106 |
| | several | US20060037106 |
| | 2,4-D dioxygenase | US20060030488 |
| | serine carboxypeptidase | US20060085872 |
| | several | USRE38,446; 6,716,474; |
| | | 6,663,906; 6,476,295; |
| | | 6,441,277; 6,423,828; |
| | | 6,399,330; 6,372,211; |
| | | 6,235,971; 6,222,098; |
| | | 5,716,837; 6,723,897; |
| | | 6,518,488 |
| Nitrogen use | fungal nitrate reductases, mutant nitrate | US20050044585 |
| efficiency | reductases lacking post-translational | |
| | regulation, glutamate synthetase-1, | |
| | glutamate dehydrogenase, | |
| | aminotransferases, nitrate transporters | |
| | (high affinity and low affinities), | |
| | ammonia transporters and amino acid | |
| | transporters | |
| | glutamate dehydrogenase | US20060090219 |
| | cytosolic glutamine synthetase; root- | EP0722494 |
| | specific glutamine synthetase. | |
| | several | WO05103270 |
| | glutamate 2-oxoglutarate | U.S. Pat. No. 6864405 |
| | aminotransferase | |
| Abiotic Stress | succinate semialdehyde dehydrogenase | US20060075522 |
| tolerance | several | WO06032708 |
| including cold, | several | US20060008874 |
| heat, drought | | |
| | transcription factor | US20060162027 |
| Disease | CYP93C (cytochrome P450) | U.S. Pat. No.7038113 |
| resistance | several | U.S. Patents U.S. Pat. No.7038113; |
| | | 6,653,280; 6,573,361; |
| | | 6,506,962; 6,316,407; |
| | | 6,215,048; 5,516,671; |
| | | 5,773,696; 6,121,436; |
| | | 6,316,407; 6,506,962; |
| | | 6,617,496; 6,608,241; |
| | | 6,015,940; 6,013,864; |
| | | 5,850,023; 5,304,730); |
| | | 6,228,992; 5,516,671 |
| Insect resistance | several | U.S. Patents 6,809,078; |
| | | 6,713,063; 6,686,452; |
| | | 6,657,046; 6,645,497; |
| | | 6,642,030; 6,639,054; |
| | | 6,620,988; 6,593,293; |
| | | 6,555,655; 6,538,109; |
| | | 6,537,756; 6,521,442; |
| | | 6,501,009; 6,468,523; |
| | | 6,326,351; 6,313,378; |
| | | 6,284,949; 6,281,016; |
| | | 6,248,536; 6,242,241; |
| | | 6,221,649; 6,177,615; |
| | | 6,156,573; 6,153,814; |
| | | 6,110,464; 6,093,695; |
| | | 6,063,756; 6,063,597; |
| | | 6,023,013; 5,959,091; |
| | | 5,942,664; 5,942,658, |
| | | 5,880,275; 5,763,245; |
| | | 5,763,241 |

Calculations using proprietary Monsanto data, historical yield data, and other public information have shown that current transgenic crop traits, both individually and stacked, generate many beneficial, risk-reducing results. For example, a number of transgenic crop traits improve yield distribution of crops, providing greater yields and lower yield variances than their conventional, non-transgenic counterparts. In the case of Monsanto's Roundup Ready® crop seeds, producers can lower their risk of decreased yields due to competition for resources by unwanted plants such as weeds. Other current Monsanto Company transgenic crop traits like YieldGard® Plus with Roundup Ready® Corn 2 and YieldGard® VT Triple increase yield, increase yield stability, reduce yield variance and reduce risks attributed to weeds, insects, and dry weather. Transgenic crops traits under development will also be able to address risks associated with weeds, herbicide-resistant weeds, insects and weather.

In one aspect, the invention provides methods for calculating a yield distribution for transgenic crops that have few years of loss cost experience, adjusting non-transgenic, actual production history (APH) values for the effects of transgenic traits, and calculating appropriate premium discounts for transgenic crops and applying them to the underlying premium rate structure that is, in turn, applied to standard yield insurance. The APH rate may also be used as a starting point for determining rates for the two major revenue insurance programs—Revenue Assurance (RA) and Crop Revenue Coverage (CRC). The transgenic crop APH, as calculated using the methods of the invention, may be used in place of the existing APH which forms the basis for RA and CRC rates, and thus the discount would be applicable to the revenue plans and any successor to those plans as well as to standard yield insurance. Likewise, the discount would be fully applicable to “Combo” plans which combine the terms of APH, RA, and CRC coverage.

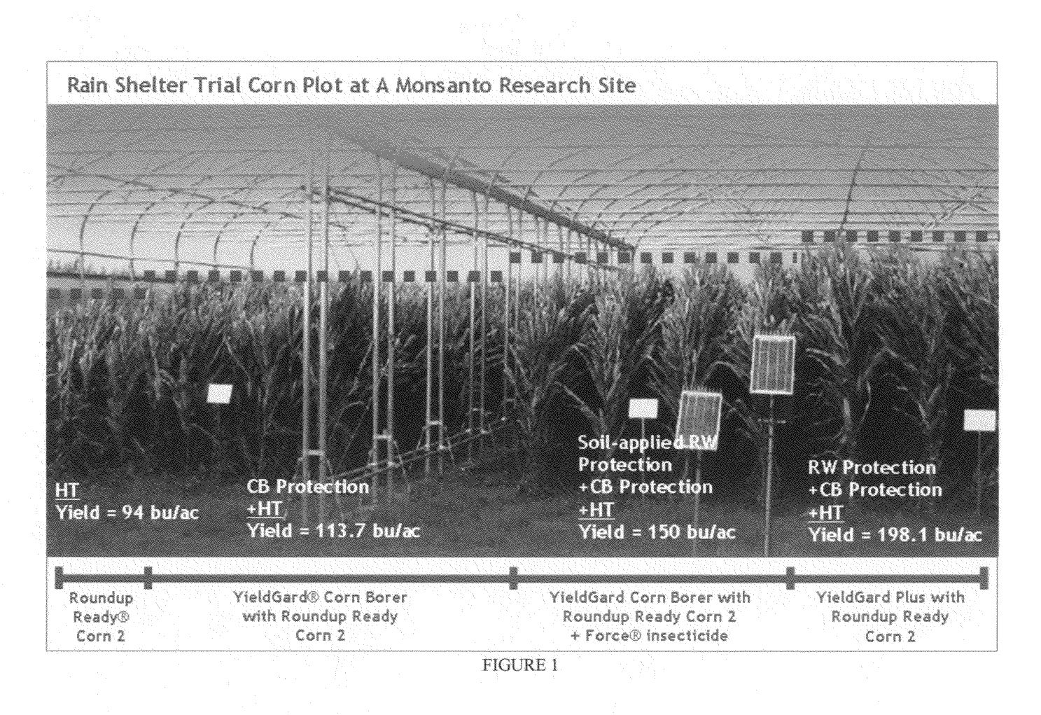

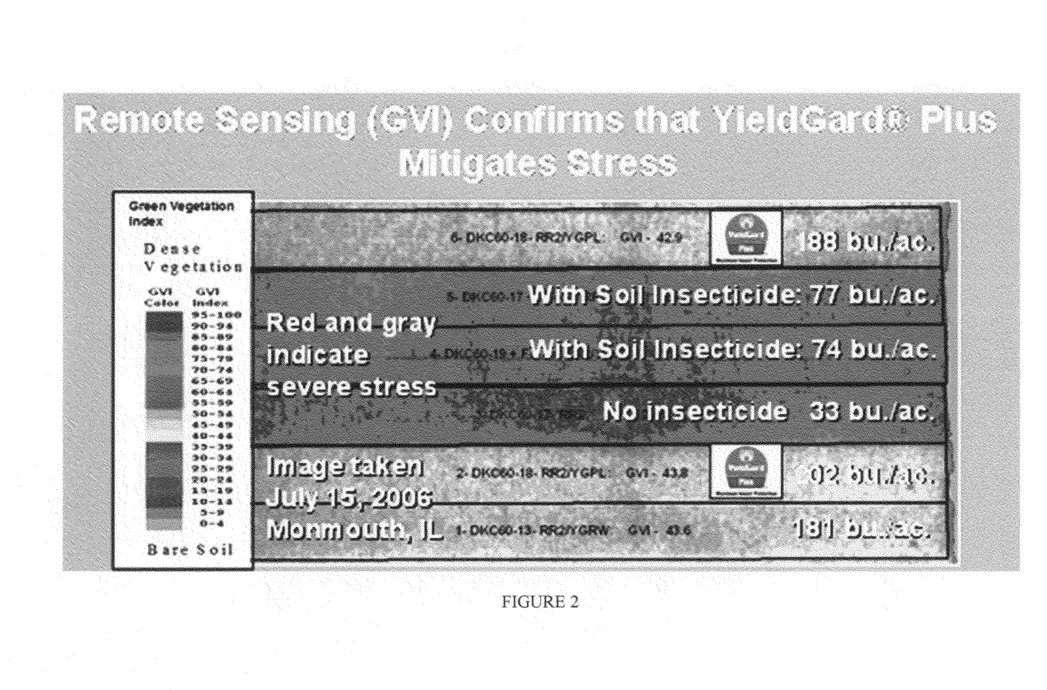

FIGS. 1 and 2 show that Monsanto's YieldGard® Corn Borer (YGCB), YieldGard® Rootworm (YGRW) and YieldGard® Plus with Roundup Ready® Corn 2 transgenic corn traits provide resistance against the corn borer and corn rootworm, insects that can cause extensive damage to corn crops and greatly diminish the crop's usable yield. FIG. 1 demonstrates the positive effects of stress mitigation are compounded by trait stacking: corn modified with the Roundup Ready® trait, on the far left of FIG. 1, has the least yield; corn modified with Roundup Ready® and YGCB traits had a greater yield; corn modified with Roundup Ready®, YGCB, and YGRW had the greatest yield (far right), even better than when a rootworm insecticide was applied to the soil (second from right). FIG. 2 shows a set of remotely-sensed crops, and demonstrates that Monsanto's YieldGard® Plus mitigates stress, which reduces risk.

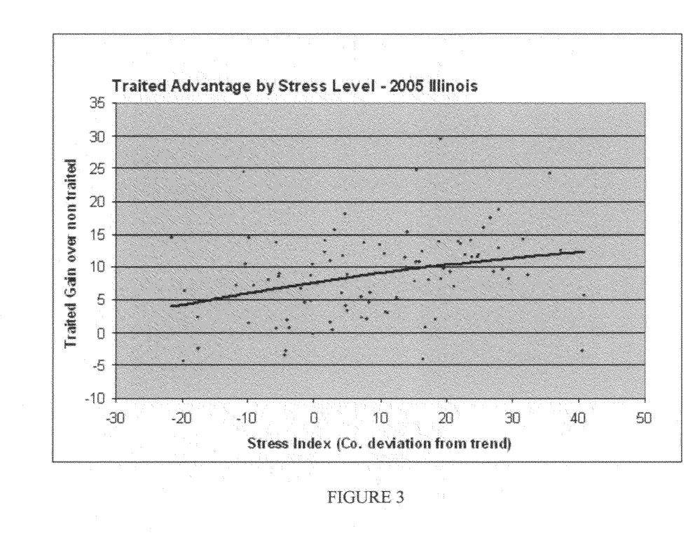

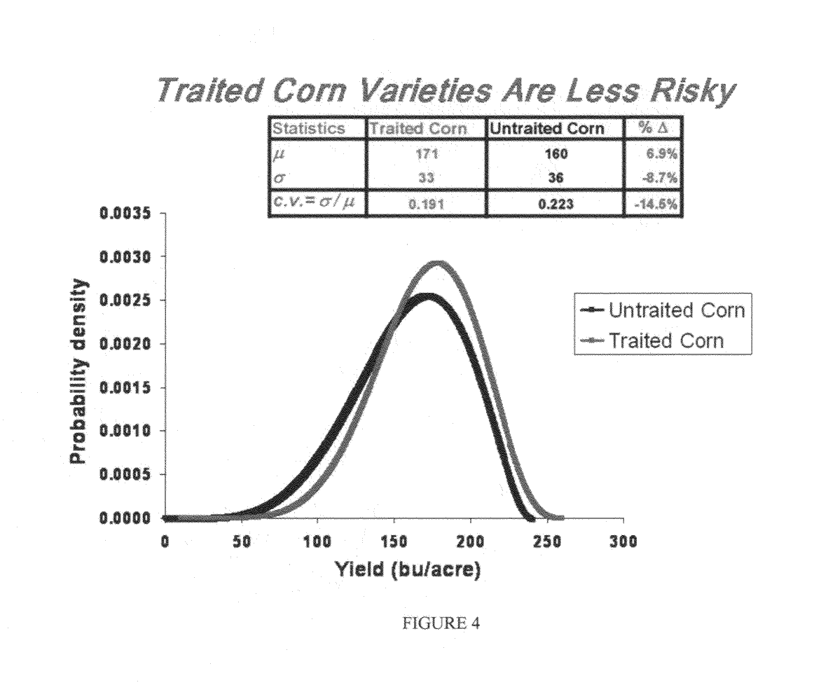

FIGS. 3 and 4 illustrate new proprietary knowledge indicating that the YGCB, YGRW, YGPL and Roundup Ready® technologies protect corn roots and vascular tissue in such a manner as to convey drought tolerance and nitrogen use efficiency, thereby reducing risks traditionally associated with adverse weather.

YGCB and YGRW transgenic corn crops thus have a smaller risk of low yield due to corn borer and corn rootworm infestation than conventional, non-transgenic corn. Thus, producers who grow pest-resistant transgenic crops (such as YGCB and YGRW transgenic corn) have a reduced risk of yield loss relative to producers of conventional, non-transgenic crops (such as conventional, non-transgenic corn), and using the methods of this invention, may enjoy lower and more actuarially-sound premiums for crop insurance.

FIG. 3 demonstrates the advantage of traited crops over non-traited crops under varying levels of stress. The advantage of traited crops becomes more pronounced as the level of stress increases. FIG. 4 shows how the advantages of traited crops over non-traited crops under conditions of stress translates into reduced risk of traited crops relative to non-traited crops—the traited crops have higher yields, less yield variance, and greater yield stability.

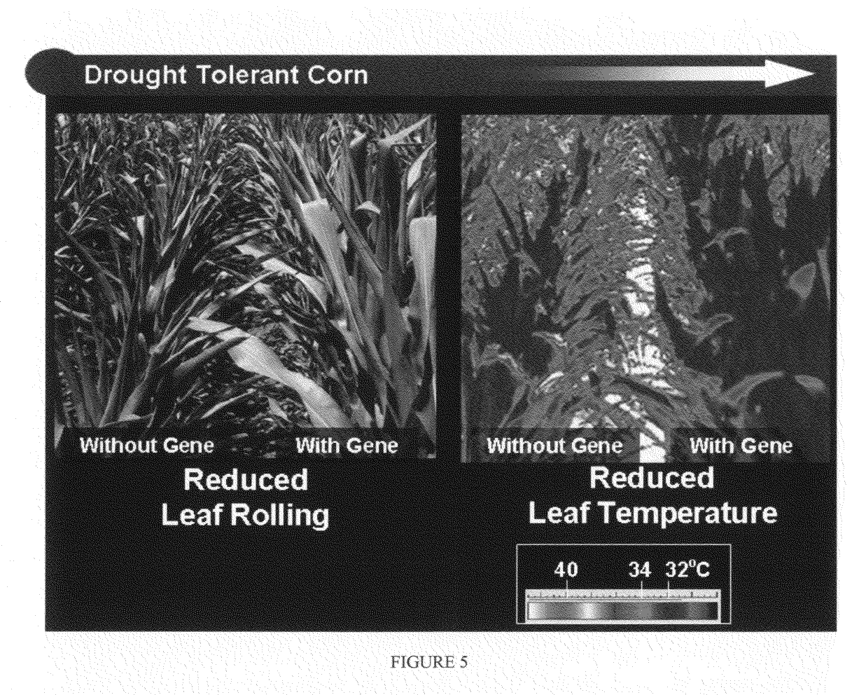

Certain genetic modifications can provide plants with improved water use efficiency and/or heat stress tolerance and other traits that impart drought resistance. FIGS. 5 and 6 show that transgenic corn and cotton crops, respectively, can be genetically-modified to contain traits that convey drought resistance.

Transgenic corn and cotton with drought resistance traits exhibit much improved performance under drought conditions whereas production of their conventional, non-transgenic counterparts may not be economically viable in drought-prone geographies. Thus, compared to corresponding conventional, non-transgenic crops, transgenic crops with drought resistance traits are less likely to produce low yields due to drought, i.e., from a financial perspective, they are inherently less risky. Producers who grow transgenic crops with drought resistance traits have a reduced risk of yield loss relative to producers of corresponding conventional, non-transgenic crops, and using the methods of this invention, may enjoy lower premiums for crop insurance. Crop producers may also choose to enter into a production agreement wherein the planting of a transgenic crop may be a condition or provision of the production agreement to reduce risk. Appropriate risk premiums for such a production agreement may be calculated using the methods of the invention. One current crop insurance practice is to insure against drought by calculating different insurance premiums for irrigated crops. The invention described here provides a new method wherein genetically-engineered technologies, in the form of transgenic crop traits, are, like irrigation, the basis for insurance against risks associated with adverse weather, dry, cold and hot, or adverse growing conditions created by plant pests.

FIG. 5 shows the benefits of drought tolerance traits in corn under drought conditions. The drought resistant corn exhibits substantially reduced leaf rolling and leaf temperature than the non-traited corn. Similarly, FIG. 6 shows the benefits of drought tolerance traits in transgenic cotton under drought conditions (right) relative to a conventional control cotton crop (left).

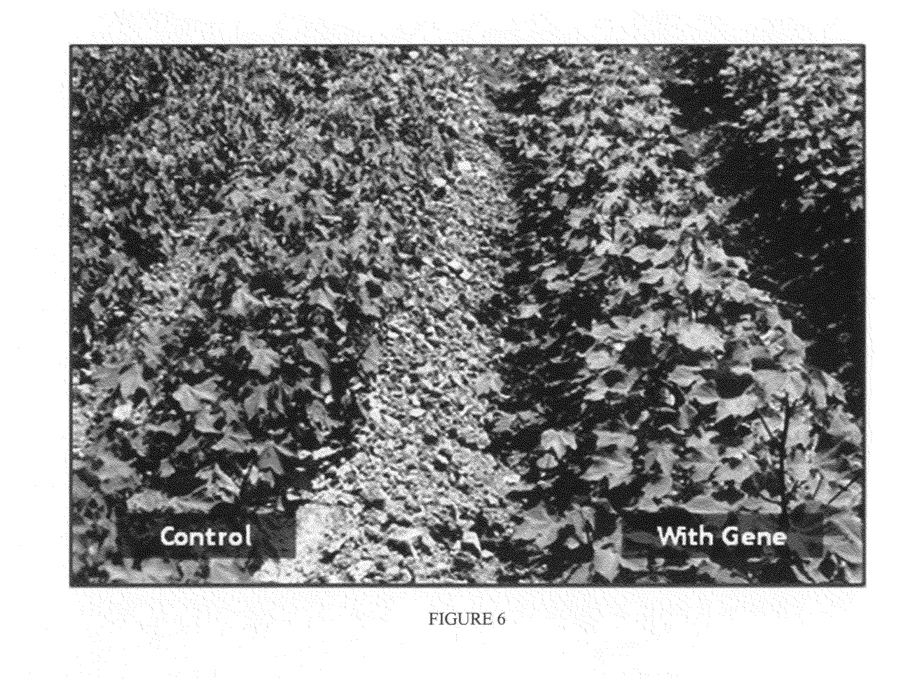

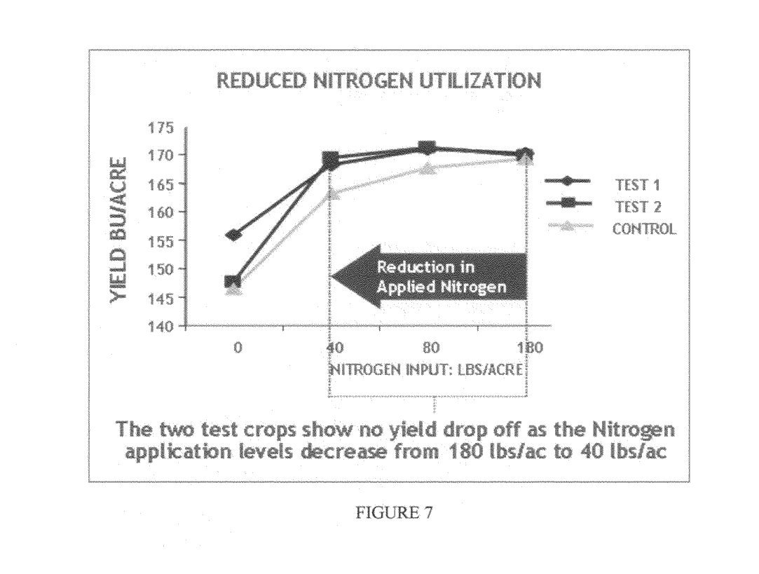

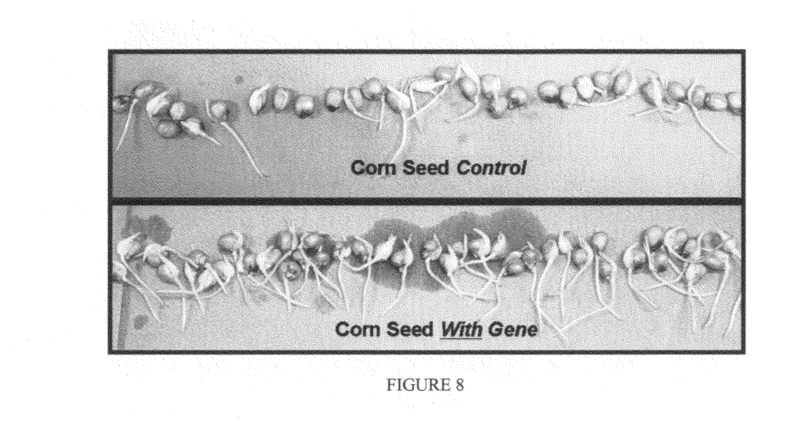

Other genetic modifications can provide plants with increased nitrogen use efficiency and cold stress tolerance. FIGS. 7 and 8 respectively, show that corn can be genetically-modified to use nitrogen more efficiently and tolerate cold during emergence. Genetically-modified corn and conventional, non-transgenic corn were tested under yield-limiting nitrogen fertilization regimes and cold, wet conditions. The transgenic corn had greater and more uniform germination than the conventional, non-transgenic corn. Producers who grow transgenic crops with cold stress tolerance traits have a reduced risk of yield loss due to excessively cold growing seasons relative to producers of corresponding conventional, non-transgenic crops, and using the methods of this invention, may enjoy lower premiums for crop insurance.

Increased yield is a benefit of transgenic crops containing single or multiple traits such as herbicide resistance, pest resistance, heat stress tolerance, drought tolerance, cold stress tolerance, and any of a number of other transgenic traits including, for example, efficient nitrogen usage. FIG. 4 shows yield probability curves for a conventional, non-transgenic crop and a transgenic crop, in this case corn. The increased yield of the transgenic crop is reflected in the rightward shift of the transgenic curve relative to the conventional curve. Also noteworthy is the narrower distribution of the transgenic curve relative to the conventional curve, reflecting a decreased statistical variance in crop yield relative to the corresponding conventional crop. This decreased statistical variance in yield, or so called “yield stability” is another benefit of transgenic crops over corresponding conventional crops, which allows greater reliability of yield predictions for financial instruments such as production agreements and insurance policies that rely on crop yield predictions.

Multiple genetic modifications can be introduced into a transgenic plant leading to combined or so-called “stacked” traits. Stacked traits can provide additional benefits and greater, more stable yields than individual traits. For example, a crop that has both heat stress and cold stress resistant traits has a lower risk for decreased yields due to both extreme heat and extreme cold, and the yield of such a crop would be greater than its conventional, non-transgenic counterpart under unusually hot or unusually cold growing seasons. Other examples of transgenic crops containing multiple traits are Monsanto's YieldGard® Plus, which is a stacked combination of YieldGard® Rootworm with YieldGard® Corn Borer, and YieldGard® Plus with Roundup Ready® Corn 2, which offers the above-and-below the ground insect protection of YieldGard® combined with Monsanto's herbicide-tolerant technology, Roundup Ready®. These stacked traits allow transgenic crop producers to control a broader spectrum of pests than they could control with a single trait.

Some embodiments of the inventions described herein have, for the first time, actuarially defined the impact of transgenic crop traits on the financial risk of transgenic crop producers. In effect, producers who grow crops with transgenic traits bear less financial risk and, therefore, warrant lower insurance premiums. This discovery enables creation of insurance products, production agreements, derivative contracts, and other financial instruments that enable transgenic crop producers to leverage their enterprises against uncertain fluctuations in yield and revenue. Given: (1) the rapid commercialization (since 1996) of transgenic crops and the concomitant lack of robust, actual production histories for transgenic crops that enable traditional, actuarial calculation of crop insurance products and financial instruments, (2) the empirical, positive impacts of transgenic crop traits on crop performance and (3) the discontinuous rates of crop performance improvement made possible by the rapidly advancing science of genetic modification, the present invention provides a novel method for collecting data in a shorter time frame than that required for traditional crop insurance and APH-related financial instruments, and using that data in unique ways to calculate a “risk correlation” that reflects the impact of genetically-engineered crop traits on the yield of transgenic crops. In addition, the present method includes a novel algorithm that employs the “risk correlation” to adjust crop insurance and production agreement premiums for the protection against risk provided by transgenic crop traits. It follows that the present invention can be employed to adjust risk premiums for current insurance products or form the basis for new insurance products, production agreements or financial instruments.

Some embodiments of the invention include a crop testing system particularly suited to the rapid collection of information about transgenic crops and transgenic crop traits. These embodiments include establishment of comparable, side by side plots of plants with and without transgenic crop traits, located on commercial farms, research farms, or in greenhouses. In some embodiments, the side by side plots in the testing system may compare transgenic crop plants with their nearest genetic relatives or isolines. In other embodiments, the side by side plots may compare transgenic crop plants with crop plants that comprise a local, commercial standard or control. The side by side crop comparisons may be incorporated into traditional statistical designs, e.g., split plots or randomized complete blocks.

Some embodiments of the invention's testing system involve collection of field information using hand-held data collection devices and terminals that: (a) accelerate data collection and analysis via utilization of software customized to record observations of side by side comparisons and experiments containing transgenic crops and (b) download the data collected into computers in formats and databases customized for retrieval and storage of information about transgenic crops. Some embodiments include a software application created to retrieve data from large databases in forms particularly suited to evaluation of risks associated with crop production, actuarial analyses, the rating of crop insurance products and establishment of risk premiums.

As used herein, the term “risk premium” refers to a value assigned to the risk of loss for insuring, for example, a particular crop. The term “actual production history yields” refers to the average crop yield over some period of time for a particular producer or a particular region. The term “measured yield distributions” refers to the statistical distributions or spreads of measured crop yields, and, similarly, the term “crop yield distributions” refers to the statistical distributions or spreads of crop yields. The term “remote sensing methodology” refers to any means for measuring crop yield or crop thriving based upon remote sensing data, for example, by measuring sunlight reflected from a large area of crops and evaluating greenness, or by measuring infrared emissions from a large area of crops. The term “estimate risk” refers to the process of determining a risk premium.

In one embodiment, the invention includes a method for pricing insurance policies on transgenic crops. In this embodiment, the financial cost of the risk of loss associated with a transgenic crop is calculated. The financial cost of the risk of loss associated with transgenic crops will generally be less than that for corresponding conventional, non-transgenic crops. The difference between the financial cost of the risk of loss associated with transgenic and corresponding conventional crops is determined, and the insurance premium for the transgenic crop is reduced by an amount based upon that difference.

In some embodiments, the transgenic crop producer, who also pays the insurance premium, may pay more for the seeds to grow the transgenic crop relative to the cost of seeds to grow a corresponding conventional crop. The difference between the cost of the transgenic seeds and the cost of the corresponding conventional seeds may be based upon the difference between the financial risk of loss associated with the transgenic and conventional crops. In some embodiments, the seed cost difference may be paid by the transgenic crop producer only if the risk mitigation benefits of the transgenic trait (traits) are realized. In these embodiments, the risk mitigation benefits of the transgenic trait(s) may be determined, for example, by evaluating the crop yield or crop composition as determined using crop analytics. That risk mitigation benefits on crop yield may be expressed in total crop output, i.e. the product of a yield unit times the concentration of a crop component. An example would be protein yield for a corn crop wherein the yield unit (bushels per acre) would be multiplied by the protein concentration in grain (percent) to determine protein yield per acre characteristic, Crop yield can be evaluated by determining actual crop yield or by using yield data gathered by yield monitors and indices derived from algorithms analyzing remotely-sensed imagery. For example, a farmer may plant drought-tolerant transgenic corn, and pay more for the drought-tolerant transgenic corn seeds than for conventional corn seeds. However, if the crop fails or yield is substantially diminished due to hot, dry weather, the farmer may receive a refund of the premium paid for the transgenic corn seeds. Alternatively, the farmer may initially pay the same for the transgenic corn seeds as for conventional corn seeds, but pay an additional premium for the transgenic corn seeds on harvest if the yield of the transgenic crop fell within a predetermined acceptable yield range as determined by direct yield measurements or yield values estimated by yield monitors or remote sensing techniques.

One aspect of certain methods of the invention involves calculating or determining a discount rate for insurance on crops having transgenic traits. To determine the discount rate, define yₜ^{NT} to be the traditional non-traited variety yield for a given acre of corn in year t. Likewise, define Yₜ^{BT} as the genetically modified (traited) variety yield. Now, let dₜ=yₜ^{BT}−yₜ^{NT} be the observed difference between the traited and non-traited yields for a given side-by-side comparison in year t. Typically, when traditional non-traited corn yields are low due to unfavorable growing conditions, the difference between the traited and traditional corn yields will tend to be greater. That is, the traited varieties suffer-less of a yield shortfall during unfavorable growing conditions. This implies a negative correlation relationship between the observed yield differences d, and the yields of non-traited varieties yₜ^{NT}. The correlation coefficient ρ=Corr(dₜ, yₜ^{NT}) should thus be negative and (statistically) significantly different from zero. The use of the correlation coefficient ρ in this unique manner represents a novel method for measuring the ability of a transgene, a combination of transgenes, or any other plant trait to mitigate stress of all types. Applied in the manner of this invention, ρ=Corr(dₜ, yₜ^{NT}) becomes a “risk correlation” that provides a new method and parameter for determining if a transgenic or non-transgenic trait is a genuine risk management tool. The correlation coefficient ρ and the yield difference dₜ may also be used in calculating a premium discount.

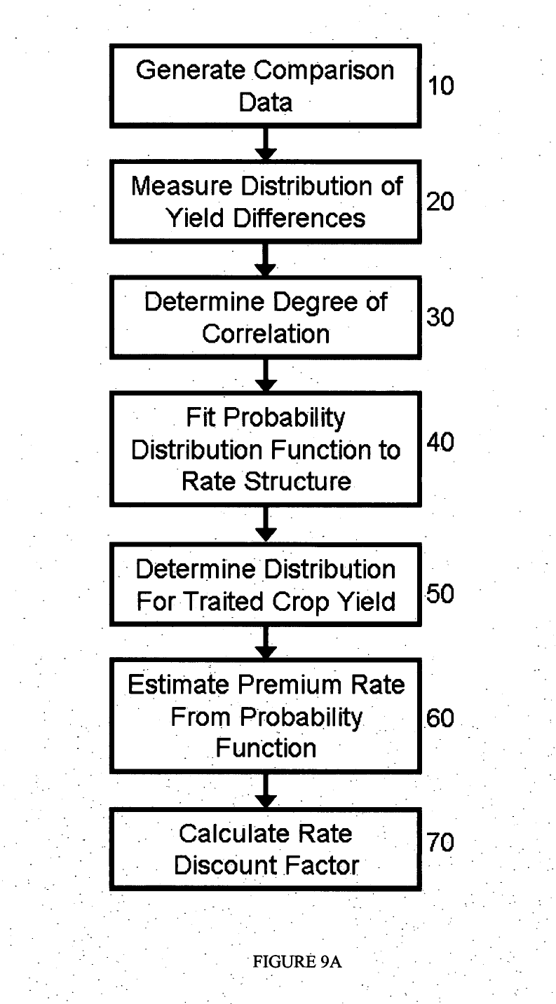

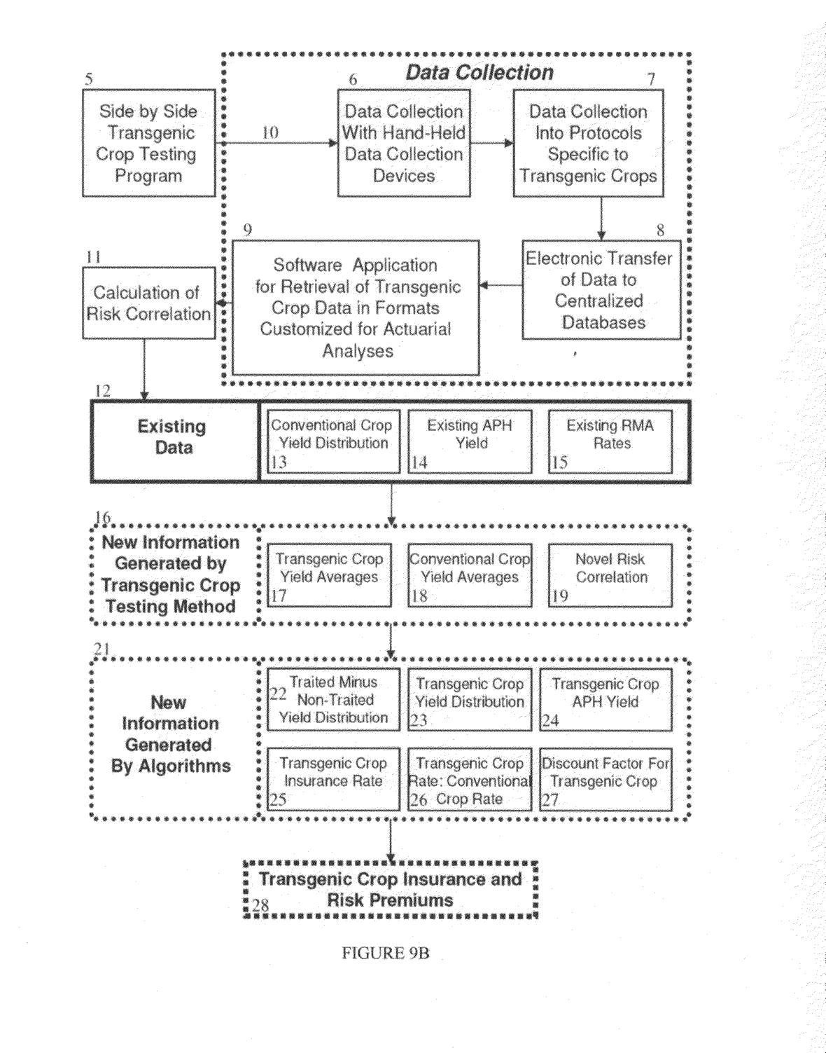

FIGS. 9A and 9B illustrate methods and systems for calculating a premium discount. In step 10, data from side-by-side field trials 5 involving different locations in a geographical area, e.g. a state or county, may be observed over some time (e.g., one or more years). The data may be collected, for example, using hand-held data collection devices 6, for example PDAs, using data collection protocols 7 specific to transgenic crops. The data collected may be transferred through a wireless connection, for example, to a centralized database 8. A software application running on a computer system 9 may be used to retrieve the transgenic crop data for use in subsequent analyses.

Calculation of risk correlation 11 may be performed on a computer means, for example, an insurer's server. Data input into the computer system may include preexisting data, including yield distribution data for a corresponding conventional crop 13, APH yield data 14 for the conventional crop, and existing Risk Management Agency (RMA) rates 15 for the conventional crop. Step 20 measures the distributional properties of the observed traited versus non-traited yield differences and step 30 measures the degree of correlation between the non-traited yields and the yield differences. An assumption may be made that the current RMA rating methods, which are based upon a collection of empirical loss-cost ratios from 1975 forward, accurately reflect the insurable risks covered by the MPCI insurance program for the traditional non-traited varieties (although such an assumption is not necessary). Using the existing rate structure 15 and an individual insured's expected (APH) yield 14, in step 40, a probability distribution function (for example, a beta probability distribution function) may be fit to the existing RMA rating structure. A beta distribution is the preferred choice for fitting because of its consistency with the characteristics of crop yield distributions and the RMA system of rate differentials for these crops, and because RMA has accumulated considerable experience working with the beta distribution in the rating of RA and RA-HPO crop revenue insurance plans. Probability distributions other than a beta may be employed when they offer a better statistical fit for various crop applications in the method.

Using the novel methods of the invention, new actuarial information 21 related to expected performance of transgenic crops may be generated using a computer means, for example an insurer's server. In step 50, a distribution for transgenic traited crop yields 23 may be simulated by drawing correlated random variables from the beta distribution for traditional crop yields 13 and the estimated distribution of the transgenic-traditional yield differences 22. An estimated correlation structure 19 may be calculated from the side-by-side test plot data for a given geography. In step 60, this distribution may be used to estimate actuarially-sound premium rates for the traited variety 28. Step 70 calculates a proportional rate discount factor 27 by considering the ratio of the implied traited rate 25 to the rate charged to the same grower under the current rating system 26. The insured may thus benefit from a discount to existing standard yield insurance (APH). In addition, this discounted APH rate may be used in place for the existing APH rate forming the basis of RA and CRC revenue insurance rates. The method thus allows for calculation of actuarially-sound insurance and risk premiums for transgenic crop production systems and insurance rates that fit seamlessly into the RMA rating system.

The following example provides a demonstration of certain embodiments of the invention, but in no way limits the scope of the invention.

### EXAMPLE

Data employed to assess the effects of transgenic, triple-stack traits upon corn yield risk were collected from many field experiments, i.e. side by side comparisons, conducted at numerous locations in cooperation with a diverse group of farmer cooperators. The data set in this example contains 1,637 separate comparisons from the 2001-2006 crop years in four states. The data include 734 yield comparisons from Illinois, 250 from Indiana, 441 from Iowa, and 212 from Minnesota. The data are single replications per location that compare the yield performance of corn hybrids with and without transgenic traits on commercial farms. Geographic dispersion of the comparisons gives a good structural representation of variation across growing conditions that would be expected to occur through time. While the data in this example were collected on commercial farms, similar data could be collected from research farms.

The comparisons, conducted on-farm, were planted, fertilized and sprayed with commercial equipment according to local farming practice. Plots were managed in the same manner as commodity corn and their length varied from 20-foot rows to hundreds of feet. All management practices, including fertility, were the decision of each farmer cooperator so that each experiment's results are reflective of what would normally be expected on a commercial farm. Corn grain yield was calculated by measuring the weight of corn in each plot with weigh-wagons, on-farm scales or scales at local grain elevators. All plot entries from a single location were measured with the same device. Yield was expressed as #2 yellow corn at 15.5% moisture.

In this analysis, any comparison of triple-stack versus conventional corn hybrids was discarded if protocols did not include local best management practices. In addition, all conventional corn hybrid treatments described as a “non-treated check” were eliminated from the data set. In order to measure underlying pest pressure for an experiment, non-treated checks are seldom treated with insecticides and/or herbicides. Accordingly, they are not representative of commercial farming practices. The field data collection methods used in this analysis represent the closest approximation to actual farm conditions that one can achieve when scientifically comparing hybrids, products, and cultural practices.

### Empirical Analysis of Rating Factors

Corn hybrids containing three “stacked,” transgenic traits developed by the Monsanto Company comprise the traited hybrids considered in this example: Roundup Ready® Corn 2 (RR2), Yieldgard Corn Borer® (YGCB), and Yieldgard Rootworm® (YGRW). These traits have been introduced alone and in combination over the last several years. Among the data collected, large yield effects are most prominent in the stacked varieties. Using the side-by-side yield data, the degree of correlation between the transgenic yield minus the traditional yield differences and the traditional yields was evaluated. The distributional properties of the yield differences (i.e., the mean and standard deviation of the differences) were also considered.

Table 2 presents summary statistics for the analysis of correlation coefficients and yield differences for all of the traited varieties. The correlation coefficients are negative and statistically significantly different from zero in every case with the stacked traits exhibiting generally larger degrees of negative correlation between yield differences and non-traited yields. Likewise, the average yield differences between the transgenic and traditional non-traited crop varieties are generally higher for stacked traits such as Yieldgard® Plus (YGCB+YGRW) and triple-stack (YGCB+YGRW+RR2) varieties. The particular trait combination in this example, the triple-stack hybrid, has an average yield advantage over traditional, non-transgenic varieties of 11.32 bushels/acre. In addition, the correlation coefficient between the yield difference and the non-traited variety yield is −0.3514. This is based upon data from 1,637 side-by-side field experiments throughout the four states targeted by this study.

TABLE 2
Summary Statistics for Correlation and Yield Difference Analysis

| | Year | | | | Average | Average | Average |
|---|---|---|---|---|---|---|---|
| | Commercially | Pearson | | p-value | Yield | Non-Traited | Traited |
| Trait | Introduced | Correlation | No. | H₀:ρ = 0 | Difference | Yield | Yield |
| RR | 1996 | −0.1245 | 1,369 | 0.0000 | −2.3225 | 173.5656 | 171.5606 |
| YGCB | 1997 | −0.1824 | 7,865 | 0.0000 | 3.4935 | 180.8104 | 184.8865 |
| RR/YGCB | 1998 | −0.1818 | 1,279 | 0.0000 | 1.9134 | 175.3669 | 176.8655 |
| RR2 | 2001 | −0.1773 | 4,149 | 0.0000 | 5.0512 | 179.4728 | 184.6303 |
| RR2/YGCB | 2001 | −0.2318 | 4,354 | 0.0000 | 6.2772 | 180.3669 | 187.1864 |
| YGPL | 2003 | −0.4662 | 1,406 | 0.0000 | 8.8564 | 185.8889 | 194.4249 |
| YGRW | 2003 | −0.3199 | 1,379 | 0.0000 | 3.4699 | 181.3871 | 184.8797 |
| YGRW/RR2 | 2003 | −0.2934 | 1,602 | 0.0000 | 11.8362 | 184.2062 | 196.2967 |
| RR2/YGPL | 2005 | −0.3514 | 1,637 | 0.0000 | 11.3234 | 180.7046 | 192.9333 |

The Pearson correlation reported in Table 2 shows the novel “risk correlation” in the invention. As employed in this method, that parameter represents the first estimation of the ability of transgenic crops to mitigate abiotic and biotic stresses.

Different counties typically have different underlying growing conditions. These differences could reflect factors such as differences in soils, weather patterns, stress factors, and any number of other observable or unobservable characteristics. To account for heterogeneity in the yield differences and correlation patterns across areas with different agronomic structures, quantiles of the 2007 reference premium rates (for 65% coverage) were considered and the counties were divided into three distinct “Rate Classes,” based upon RMA's underlying base reference rates. Class 1 consists of all counties with rates less than or equal to 0.022; Class 2 consists of all counties with rates greater than 0.022 and less than or equal to 0.033; and Class 3 consists of all counties with base rates above 0.033.

Table 3 presents summary statistics for the yield differences with a breakdown by the rate-classes. Higher rate classes tend to correspond to slightly lower yield differences. Likewise, as expected, higher rates (corresponding to higher inherent yield risk) are associated with lower average yields, both for non-traited and transgenic traited crops. However, the yield advantage for traited varieties is maintained across the board, with average differences of 12.56, 10.44, and 8.43 bushels/acre for rate classes 1, 2, and 3, respectively.

TABLE 3
Summary Statistics for Yield Differences for RR2/YGPL Varieties

| | | |
|---|---|---|
| | | Standard Error |
| Variable | Mean | of Mean |

Rate Class 1

| | | |
|---|---|---|
| Yield Difference | 12.5564 | 0.6268 |
| Traditional Yield | 186.4630 | 0.9195 |
| Triple-stack Yield | 199.0195 | 0.8298 |

Rate Class 2

| | | |
|---|---|---|
| Yield Difference | 10.4354 | 0.7622 |
| Traditional Yield | 176.3739 | 1.3514 |
| Triple-stack Yield | 186.8092 | 1.3468 |

Rate Class 3

| | | |
|---|---|---|
| Yield Difference | 8.4312 | 1.4067 |
| Traditional Yield | 167.6893 | 2.6265 |
| Triple-stack Yield | 176.1205 | 2.5932 |

Note:
Rate Classes are defined using RMA's 2007 base reference rates. Class 1 consists of all counties with rates less than or equal to 0.022; Class 2 consists of all counties with rates greater than 0.022 and less than or equal to 0.033; and Class 3 consists of all counties with base rates above 0.033.

Tables 4A and 4B present t-tests of the statistical significance of the average differences across the different rate classes. The evidence favors statistically significant differences in the average yield differences for rate class 1 with classes 2 and 3. In contrast, the testing results suggest that the rate differences for classes 2 and 3 are not statistically significantly different. Such statistical testing may be influenced by non-independence in the individual observations of rate differences. To the extent that such non-independence exists, the measures of average differences, correlation coefficients, and the parameters describing the distribution of yield differences remain unbiased and consistent.

TABLE 4
Test of Equality of Mean Differences Across Rate Classes
A. t-Tests of Differences in Mean Differences

| Mean | Test | Variance | | | |
|---|---|---|---|---|---|
| Comparison | Type | Assumption | df | t-test | p-value |
| 1 vs. 2 | Pooled | Equal | 1,429 | 2.13 | 0.0333 |
| | Satterthwaite | Unequal | 1,202 | 2.15 | 0.0318 |
| 1 vs. 3 | Pooled | Equal | 1,084 | 2.82 | 0.0049 |
| | Satterthwaite | Unequal | 292 | 2.68 | 0.0078 |
| 2 vs. 3 | Pooled | Equal | 755 | 1.32 | 0.1861 |
| | Satterthwaite | Unequal | 332 | 1.25 | 0.2112 |

B. Folded-Form F-Test of Equality of Mean Variances Across
Rate Classes

| Mean | Num | Den | | |
|---|---|---|---|---|
| Comparison | df | df | F-test | p-value |
| 1 vs. 2 | 879 | 550 | 1.08 | 0.3199 |
| 1 vs. 3 | 205 | 879 | 1.18 | 0.1215 |
| 2 vs. 3 | 205 | 550 | 1.27 | 0.0321 |

Breakdown of the correlation coefficients across the three different rate classes was also considered. Table 5 presents both Pearson product-moment and Spearman rank correlation coefficients for the three different rate classes. The degree of negative correlation is less for higher rate classes. However, the correlation remains highly statistically significant (different from zero for one-tailed and two-tailed tests) in every case.

TABLE 5
Pearson and Spearman Correlation Coefficients:
By Rate Class

| | Pearson | | Spearman | |
|---|---|---|---|---|
| Rate | Correlation | p-value | Correlation | p-value |
| Class | Coefficient | rho = 0 | Coefficient | rho = 0 |
| Rate Class 1 | −0.47693 | 0.0001 | −0.42885 | 0.0001 |
| Rate Class 2 | −0.28797 | 0.0001 | −0.29431 | 0.0001 |
| Rate Class 3 | −0.29126 | 0.0001 | −0.32463 | 0.0001 |

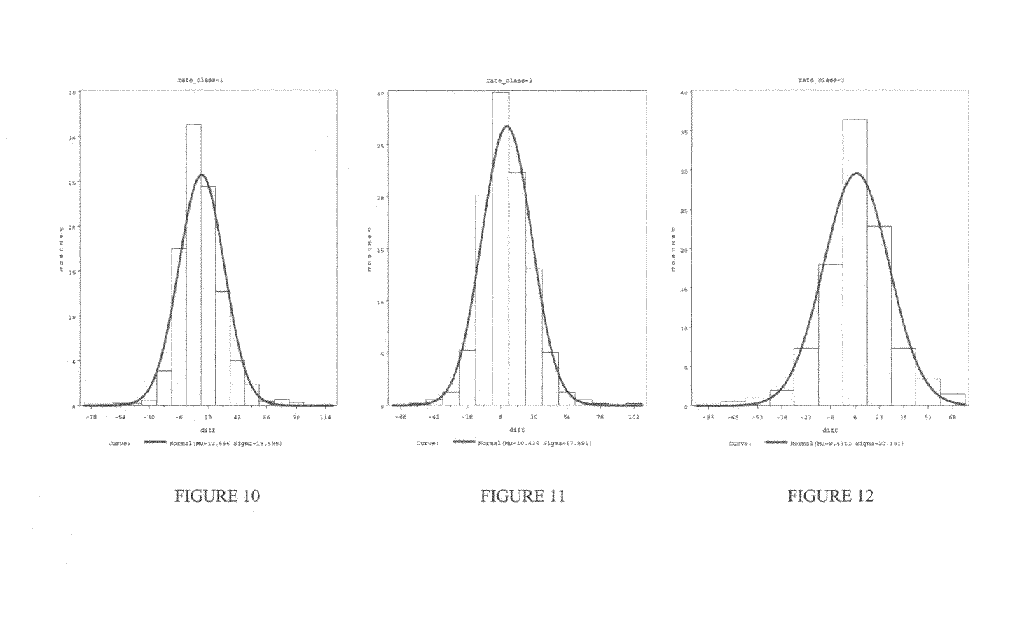

Next, the distributional properties of the yield differences were considered. A variety of parametric distributions were considered, and a simple normal distribution was selected. Normal distributions were fit to the yield differences across the three rate classes. The resulting densities are illustrated in FIGS. 10-12. The histograms constructed from the side-by-side, genetically modified versus traditional (traited versus non-traited) yield differences closely resemble normal distributions and thus support the selection of a normal distribution.

The side-by-side yield data in this example is comprised of longitudinal-type data. Although the estimates of correlation and the parameters of the yield difference distribution remain unbiased, this raises potential concerns of spatial correlation, which could affect inferences. A block bootstrapping procedure was used to assess the extent to which such non-independence could impact the estimates. (For details on block bootstrapping, see, e.g., P. Hall, J. Horowitz, and B. Jing, “On Blocking Rules For The Bootstrap With Dependent Data,” Biometrika 1995, 82(3):561-574.) Under block-bootstrapping, groups of dependent observations (blocks) are defined and sampled from rather than sampling from individual observations as is done in traditional bootstrapping methods. This maintains dependence within the blocks, which are assumed to be independent. Blocks made up of two different groupings were considered: counties and crop reporting districts (CRDs). The bootstrapped estimates of correlation and mean yield differences (for 1,000 bootstrap replications) are presented in Table 6. The standard errors associated with the estimates rise very slightly as one moves to higher levels of aggregation. However, the results are robust to the blocking alternatives and thus the original analysis based on the sample data forms the basis for the rating process.

TABLE 6
Block Bootstrap Estimates of Correlation Coefficients and
Mean Triple-Stack (YGPL + RR2)-Traditional Corn Yield Differences

| | | County Block | | CRD Block | |
|---|---|---|---|---|---|
| | | Bootstrap | | Bootstrap | |
| Rate | | | Std | | Std |
| Class | Parameter | Mean | Dev | Mean | Dev |

Correlation Coefficients

| | | | | | |
|---|---|---|---|---|---|
| All | Pearson Correlation Coefficient | −0.3498 | 0.0301 | −0.3497 | 0.0413 |
| All | Spearman Correlation Coefficient | −0.3504 | 0.0245 | −0.3496 | 0.0340 |
| Rate Class 1 | Pearson Correlation Coefficient | −0.4744 | 0.0406 | −0.4761 | 0.0429 |
| Rate Class 2 | Pearson Correlation Coefficient | −0.2859 | 0.0472 | −0.2874 | 0.0619 |
| Rate Class 3 | Pearson Correlation Coefficient | −0.2894 | 0.0800 | −0.2995 | 0.0690 |
| Rate Class 1 | Spearman Correlation Coefficient | −0.4270 | 0.0319 | −0.4281 | 0.0306 |
| Rate Class 2 | Spearman Correlation Coefficient | −0.2915 | 0.0412 | −0.2913 | 0.0549 |
| Rate Class 3 | Spearman Correlation Coefficient | −0.3237 | 0.0671 | −0.3264 | 0.0512 |

Mean Yield Differences

| | | | | | |
|---|---|---|---|---|---|
| All | Mean Yield Difference | 11.3140 | 0.6268 | 11.2496 | 0.9373 |
| Rate Class 1 | Mean Yield Difference | 12.5433 | 0.9508 | 12.4974 | 1.1322 |
| Rate Class 2 | Mean Yield Difference | 10.4126 | 0.9094 | 10.3232 | 1.1460 |
| Rate Class 3 | Mean Yield Difference | 8.4200 | 1.4502 | 8.3587 | 1.9565 |

### The Rating Process

In this example, the rating process is comprised of two basic steps. First, a beta density is calibrated to the RMA rate structure for a given underlying premium rate and APH yield (which represents RMA's estimate of the expected yield, which may be used as an estimate of the mean yield). Second, this estimated beta distribution is used along with the estimated correlation coefficients and the distribution of the yield differences to simulate the implied distribution of the traited yield. This involves taking a random draw from the beta distribution (representing a realization of the traditional yield) and a correlated random draw from the transgenic-traditional yield difference. The sum of these two quantities represents a realization of the transgenic (traited) yield. This is repeated a large number of times (one million replications in this example) and, from the implied distribution of traited yields, a premium rate for each coverage level is calculated.

The expected difference between the transgenic traited and the non-traited yield, (the expected yield difference, e.g., 11 bushels per acre), may be determined from the side-by-side field experiment data. Furthermore, the vast majority of the loss-cost experience making up the rate is based upon traditional corn varieties. (This example does not account for the quantity of individual growers' yield history included traited varieties.)

Under the RMA's basic rating procedure, an individual's premium rate is based upon the following expression:

$$\begin{matrix}{TR}_{i} = [ VRP + FRP ] \cdot CLD \\ = [ \frac{( ( Reference Rate ) \cdot {( \frac{{Y}_{i}}{RY} )}^{E} + Fixed Rate ) \cdot CLD}{UDF} ]\end{matrix}$$

where TRᵢ is defined as the total rate of the i^{th} individual, VRP is the variable rate portion, FRP is the fixed rate portion, CLD is the proportional coverage level differential, Yᵢ is the unit's approved APH yield, RY is the reference yield for the crop in the county, E is an exponent parameter, and the UDF is a unit division factor. The reference rate, the fixed rate, the reference yield, the exponent, and the coverage level differentials are all constant at the county level. However, an individual's premium rate adjusts according to the ratio of their APH yield and the reference yield.

In the numerator, an individual's premium rate is given by the sum of two parts—a fixed rate portion and a variable rate portion. The variable rate portion is determined by the product of an individual's base rate and an adjustment factor which is given by the ratio of their APH yield to the reference yield for the county, raised to an exponent. The exponents, typically around −2.0 in the pilot region, serve to adjust an individual's rate on the basis of a comparison of their average yield to the county reference yield. The implicit assumption is that individuals with a higher average yield relative to the county tend to have lower risk and thus receive a rate discount while the opposite is true for individuals with yields beneath the reference yield. The sum of the fixed and variable portions of the rate is then scaled up or down by a coverage level differential (commonly called the “rate relativity”). In this example, there is no reason to suspect that the unit discount factor (a factor used to adjust rates downward for individuals that insure all of their farm units together rather than on an individual basis) would be affected by the adoption of traited crop varieties, so changes to this factor are not considered here.

Current RMA rating procedures do contain an inherent discount factor to reward individuals with higher average yields. This example demonstrates that the RMA's inherent discount (which is driven by the yield index (Yᵢ/RY) and the exponent) is not sufficient to account for the risk reduction from genetically modified crops, and that the methods of the present invention are required to properly calculate a discount. All of the discounts determined in this example are relative to the APH-adjusted (discounted) rate that an individual would actually pay and not the rate implied by the non-traited traditional yield.

The rating process can be illustrated by the following steps.
1. An individual who has adopted the traited variety should have an APH yield that is expected to be higher than the non-traited yield by the amount of the expected difference d̅^̅{̅r̅c̅}̅, which is allowed to differ across rate classes (rc=1, 2, or 3 in this example). Thus, their expected non-traited APH yield is given by their APH yield minus the expected yield difference E(yᵢ^{NT})=APHᵢ− d̅ᵢ̅^̅{̅r̅c̅}̅.
2. On the basis of the county reference rate, rate differentials, exponent, and reference yield, a beta density is calibrated to the expected non-traited yield.
3. Using the calibrated distribution for the non-traited yield, the estimated correlation coefficients and the distribution of the yield difference, the corresponding traited yield is simulated. For a given replication j, the simulated traited yield is given by yᵢ_{ⱼ}^{BT}=yᵢ_{ⱼ}^{NT}+ d̅ᵢ̅_̅{̅ⱼ̅}̅^̅{̅r̅c̅}̅, where the yᵢ_{ⱼ}^{NT} and dᵢ_{ⱼ} are drawn from the beta and normal distributions, respectively, accounting for the negative correlation.
4. From the distribution of the traited yields, new rates for each level of coverage are calculated. In addition, the rate that would be paid under the current rating system for an individual with the APH yield given above (which started the process and thus includes the yield difference effect) is calculated. This is not the rate implied by E(yᵢ^{NT}) but rather the lower rate which incorporates the discount given by the current rating system for the higher APH yield. This is the current rate that the insured would actually pay absent any discount from growing genetically modified crops.
5. Finally, a discount factor is calculated from the ratio of the new traited rate to the rate that the insured would actually pay (which, again, incorporates RMA's current discount for a higher expected yield). The rate discount factor is thus given by λ=Traited_Rate/Current_Actual_Rate.

Regarding the methods used to calibrate the beta density to the current rate structure and expected yield, the rate relativities apply adjustments to the 65% coverage rate to yield premium rates for coverage at the 50, 55, 60, 70, 75, 80, and 85% levels. This gives eight points for which to fit the beta density. The unscaled beta distribution consists of four parameters—two shape parameters (which denoted C and D) and a minimum (A) and maximum (B) possible value. The probability density function is given by

$$f ( y ) = \frac{Γ ( C + D ) {( y - A )}^{C - 1} {( B - y )}^{D - 1}}{Γ ( C ) Γ ( D ) {( B - A )}^{C + D - 1}} .$$

The mean of a beta-distributed random variable is given by:

$$\frac{AD + BC}{C + D} .$$

Thus, when the mean is determined (as is true in this example because the mean of the distribution is required to be equal to the expected non-traited yield), there are three free parameters to be estimated. The A, C, and D parameters are estimated in the calibration process.

This example used Powell's (1992) Constrained Optimization by Linear Approximations (COBYLA) implementation of the simplex algorithm. (The minimum yield was constrained to be non-negative and the shape parameters were constrained to be less than 15. In the case of a small number of northern Minnesota counties with very high rates, it was necessary to constrain the second shape parameter D to be less than 4 to obtain viable estimates. This was binding only for very small APH yields. These counties are discussed in greater detail below.) A range of start values were looped over to ensure that a global minimum was reached. The objective function was defined as the sum of the squared differences between the actual premium rate and that implied by the beta distribution. Because each individual's rate varies according to their APH yield (due to the exponent/reference yield process), it was necessary to consider the rating structure over a range of possible APH yields. The rating exercise was repeated for APH yields set at 75%-200% of the county reference yield (in 25% increments). Current reference yields are widely recognized to understate current expected yields. Because the county reference yields may not have been updated for some time, most insuring producers likely have APH yields approximately 125% of the county reference yield.

Table 7 below presents a detailed evaluation of the goodness of fit to the existing rate structure in the beta calibration. The process is able to closely match the current rating structure in nearly every case. Table 7 shows summary statistics for the difference in the actual and simulated (from the beta) rates as well as percentage differences (given by 100*(actual−simulated)/actual). The median objective function value (given by the sum of the squared errors (SSE) between simulated and actual rates) is 6.98E-07. The percentiles of the rate differences show a calibration to within the third decimal place in most cases. In only a very small number of cases does the beta not appear to closely fit the existing rate structure. This usually occurs in cases where the fits are to rates with very low APH yield (75% of the reference yield). The maximum rate difference is 15.9% of the underlying premium rate, which occurs for a rate at the 50% coverage level. The 5^{th} and 95^{th} percentiles demonstrate that this method gets within 5% of the underlying RMA rate in 90% of the cases. The only exception in this example involves the 50% coverage rate, which is slightly less accurate.

TABLE 7
Evaluation of Goodness of Fit of Calibrated Beta Density to RMA Rating Structure

| Variable | N | Mean | Std Dev | Min | 1st %-ile | 5th %-ile | Median | 95th %-ile | 99th %-ile | Max |
|---|---|---|---|---|---|---|---|---|---|---|
| Optimal | 2280 | 5.839E−05 | 6.125E−04 | 8.472E−09 | 2.814E−08 | 4.626E−08 | 6.977E−07 | 1.245E−04 | 9.338E−04 | 2.058E−02 |
| Function | | | | | | | | | | |
| Value | | | | | | | | | | |
| Rate | 2280 | 8.293E−04 | 3.851E−03 | −9.359E−02 | −1.859E−03 | −1.536E−04 | 4.469E−04 | 4.425E−03 | 8.552E−03 | 1.803E−02 |
| Difference | | | | | | | | | | |
| 50% | | | | | | | | | | |
| Coverage | | | | | | | | | | |
| Rate | 2280 | −1.096E−04 | 2.265E−03 | −5.858E−02 | −3.308E−03 | −8.720E−04 | −5.203E−05 | 1.310E−03 | 2.552E−03 | 5.091E−03 |
| Difference | | | | | | | | | | |
| 55% | | | | | | | | | | |
| Coverage | | | | | | | | | | |
| Rate | 2280 | −4.460E−04 | 1.143E−03 | −1.821E−02 | −5.291E−03 | −1.744E−03 | −2.274E−04 | 1.602E−04 | 9.628E−04 | 5.241E−03 |
| Difference | | | | | | | | | | |
| 60% | | | | | | | | | | |
| Coverage | | | | | | | | | | |
| Rate | 2280 | −5.640E−04 | 1.756E−03 | −2.741E−02 | −7.929E−03 | −3.149E−03 | −1.268E−04 | 2.407E−04 | 1.945E−03 | 2.194E−02 |
| Difference | | | | | | | | | | |
| 65% | | | | | | | | | | |
| Coverage | | | | | | | | | | |
| Rate | 2280 | −4.772E−04 | 2.547E−03 | −2.002E−02 | −8.334E−03 | −3.764E−03 | −2.518E−05 | 3.360E−04 | 8.796E−04 | 4.815E−02 |
| Difference | | | | | | | | | | |
| 70% | | | | | | | | | | |
| Coverage | | | | | | | | | | |
| Rate | 2280 | 1.914E−04 | 4.311E−03 | −1.855E−02 | −6.070E−03 | −2.301E−03 | 5.473E−05 | 5.461E−04 | 1.684E−02 | 7.465E−02 |
| Difference | | | | | | | | | | |
| 75% | | | | | | | | | | |
| Coverage | | | | | | | | | | |
| Rate | 2280 | −1.424E−02 | 6.349E−02 | −6.116E−01 | −3.634E−01 | −1.237E−01 | 6.924E−05 | 5.121E−04 | 1.604E−03 | 8.672E−03 |
| Difference | | | | | | | | | | |
| 80% | | | | | | | | | | |
| Coverage | | | | | | | | | | |
| Rate | 2280 | −1.407E−02 | 6.586E−02 | −6.156E−01 | −3.758E−01 | −1.298E−01 | −5.393E−06 | 4.469E−03 | 1.175E−02 | 3.587E−02 |
| Difference | | | | | | | | | | |
| 85% | | | | | | | | | | |
| Coverage | | | | | | | | | | |
| % Rate | 2280 | 2.695% | 3.052% | −19.217% | −4.174% | −1.006% | 2.159% | 8.079% | 11.308% | 15.941% |
| Difference | | | | | | | | | | |
| 50% | | | | | | | | | | |
| Coverage | | | | | | | | | | |
| % Rate | 2280 | −0.516% | 1.963% | −11.098% | −5.746% | −4.508% | −0.189% | 2.279% | 4.017% | 6.560% |
| Difference | | | | | | | | | | |
| 55% | | | | | | | | | | |
| Coverage | | | | | | | | | | |
| % Rate | 2280 | −0.914% | 1.185% | −6.546% | −4.489% | −3.266% | −0.712% | 0.544% | 1.680% | 5.447% |
| Difference | | | | | | | | | | |
| 60% | | | | | | | | | | |
| Coverage | | | | | | | | | | |
| % Rate | 2280 | −0.686% | 1.366% | −9.146% | −5.442% | −3.247% | −0.388% | 0.933% | 1.937% | 4.180% |
| Difference | | | | | | | | | | |
| 65% | | | | | | | | | | |
| Coverage | | | | | | | | | | |
| % Rate | 2280 | −0.461% | 1.543% | −10.785% | −5.682% | −3.384% | −0.056% | 1.196% | 2.208% | 7.411% |
| Difference | | | | | | | | | | |
| 70% | | | | | | | | | | |
| Coverage | | | | | | | | | | |
| % Rate | 2280 | 0.017% | 1.586% | −9.108% | −4.679% | −2.415% | 0.112% | 1.575% | 5.731% | 13.142% |
| Difference | | | | | | | | | | |
| 75% | | | | | | | | | | |
| Coverage | | | | | | | | | | |
| % Rate | 2142 | 0.085% | 0.747% | −5.909% | −2.895% | −1.124% | 0.158% | 0.879% | 1.419% | 4.119% |
| Difference | | | | | | | | | | |
| 80% | | | | | | | | | | |
| Coverage | | | | | | | | | | |
| % Rate | 2142 | 0.456% | 1.563% | −6.596% | −1.791% | −1.088% | 0.042% | 3.428% | 6.780% | 12.089% |
| Difference | | | | | | | | | | |
| 85% | | | | | | | | | | |
| Coverage | | | | | | | | | | |

Table 8 presents a breakdown of the goodness of fit across different APH yields. The calibration exercise was repeated at various proportions of the county reference yield (75-200% by 25 percentage-point increments). The 2007 county reference yields are quite dated in many cases and thus are usually considerably below typical APH or rate yields. Thus, the vast bulk of the insurance book is likely to have APH yields above the reference yield. Table 8 demonstrates that the fit of the beta density is strongest at higher APH yields (relative to the county reference yield). Put differently, the sum-of-squared error terms are larger at lower relative APH yields. The SSE is not scale-invariant and thus higher rates (which can be caused by lower APH yields due to the exponent discount process) will typically imply larger differences between actual and simulated rates. One approach to normalizing the SSE objective function values is to divide each by a common coverage level premium rate (the 65% level in this example). The lower portion of Table 8 presents SSE objective function values that are normalized by dividing by the 65% premium rate. The normalized statistics again demonstrate that the degree of fit for the beta is strongest at rates for higher APH yields. In contrast, for individuals with an APH yield equal to only 75% of the county reference yield, the fit of the beta, though strong, is somewhat less accurate. The insurance customers who plant transgenic (traited) crops are most likely to have relatively high APH yields, so those most likely to benefit from the methods of the invention are those for which the methods are most accurate.

TABLE 8
Evaluation of Goodness of Fit of Calibrated Beta Density to RMA Rating Structure:
By APH as Percentage of County Reference Yield

| | | | | | | | | | | |
|---|---|---|---|---|---|---|---|---|---|---|
| APH % | | | | | | | | | | |
| Ref Yield | N | Mean | Std Dev | Min | 1st %-ile | 5th %-ile | Median | 95th %-ile | 99th %-ile | Max |

SSE Objective Function

| | | | | | | | | | | |
|---|---|---|---|---|---|---|---|---|---|---|
| 75% | 380 | 2.710E−04 | 1.469E−03 | 1.090E−08 | 2.329E−08 | 6.067E−08 | 5.471E−06 | 9.627E−04 | 8.315E−03 | 2.058E−02 |
| 100% | 380 | 4.372E−05 | 1.902E−04 | 8.472E−09 | 2.306E−08 | 3.503E−08 | 1.314E−06 | 1.997E−04 | 9.305E−04 | 2.346E−03 |
| 125% | 380 | 1.499E−05 | 5.578E−05 | 2.395E−08 | 3.223E−08 | 4.403E−08 | 6.440E−07 | 9.018E−05 | 3.866E−04 | 5.690E−04 |
| 150% | 380 | 8.849E−06 | 3.417E−05 | 2.288E−08 | 2.814E−08 | 4.695E−08 | 4.260E−07 | 5.000E−05 | 2.397E−04 | 3.680E−04 |
| 175% | 380 | 6.376E−06 | 2.383E−05 | 2.277E−08 | 3.383E−08 | 5.124E−08 | 4.000E−07 | 3.514E−05 | 1.642E−04 | 2.600E−04 |
| 200% | 380 | 5.372E−06 | 1.846E−05 | 2.278E−08 | 2.995E−08 | 5.044E−08 | 4.120E−07 | 3.010E−05 | 1.206E−04 | 1.960E−04 |

Relative SSE Objective Function (Normalized by 65% Premium Rate)

| | | | | | | | | | | |
|---|---|---|---|---|---|---|---|---|---|---|
| 75% | 380 | 8.526E−04 | 2.799E−03 | 2.050E−07 | 4.690E−07 | 1.056E−06 | 9.528E−05 | 3.787E−03 | 1.576E−02 | 3.326E−02 |
| 100% | 380 | 2.720E−04 | 7.762E−04 | 2.020E−07 | 4.810E−07 | 7.820E−07 | 2.779E−05 | 1.550E−03 | 4.127E−03 | 7.469E−03 |
| 125% | 380 | 1.554E−04 | 4.491E−04 | 4.330E−07 | 8.990E−07 | 1.284E−06 | 1.845E−05 | 9.339E−04 | 2.205E−03 | 4.969E−03 |
| 150% | 380 | 1.176E−04 | 3.422E−04 | 2.530E−07 | 9.070E−07 | 1.343E−06 | 1.497E−05 | 7.088E−04 | 1.736E−03 | 3.765E−03 |
| 175% | 380 | 1.012E−04 | 2.814E−04 | 2.560E−07 | 6.290E−07 | 1.658E−06 | 1.577E−05 | 5.729E−04 | 1.439E−03 | 3.085E−03 |
| 200% | 380 | 9.840E−05 | 2.547E−04 | 1.760E−07 | 6.850E−07 | 1.725E−06 | 2.165E−05 | 5.898E−04 | 1.237E−03 | 2.668E−03 |

### Discount Adjustments

Although the discounts in this example are likely to be robust even with respect to the very few outliers that exist, certain methods of the invention include means for adjusting for any deviations. These methods employ a second order polynomial function to provide a functional rating mechanism that can be incorporated into the RMA's current rating structure and software. This polynomial function can be used to smooth over any outliers by using the predicted values from the regression function rather than the actual discounts calculated from the simulation.

This example uses the RMA's existing rates and thus adopts the implicit assumption that the current rates are accurate for the non-traited varieties of corn which make up the vast bulk of the loss-cost experience that goes into ratemaking. On the basis of procedures used to rate other RMA products (Revenue Assurance), this example adopts a beta probability distribution and calibrates it to the current rate structure. The beta distribution may not fit as well in cases of very high premium rates. The foregoing analysis reflects this point in that selected counties with very high premium rates and low APH yields may not fit a beta distribution as well. The largest base reference rate (the 65% rate minus the fixed rate load) is 38%. For an individual with a low APH yield, this can imply total premium rates approaching 50%—a level that may not reflect a highly liquid crop insurance market. As discussed below, some embodiments of the inventions exclude such high risk counties from the initial pilot area.

In simulating correlated random variables drawn from marginals from different parametric families (the beta and normal in this case), this example uses the standard approach of simulating from correlated normal random variables and using the cumulative distribution function to transform the normal variates to the appropriate marginals. This transformation preserves rank (fractile) correlation. This example thus uses Spearman rank correlation coefficients and converts them to the appropriate Pearson correlation coefficients for use in the simulation, specifically, Spearman rank correlation coefficients of −0.43, −0.29, −0.32 for the three rate classes are analogous to Pearson correlations of −0.45, −0.31, −0.34, respectively. The correction has no meaningful effect on the analysis. The simulation results are checked in the rating process to ensure that the correct degree of rank correlation is maintained throughout the simulation.

Finally, in this example, “refuge” requirements apply to the production of transgenic crops with insect resistance traits. In the case of the RR2/YGPL (triple-stack) corn varieties in this example, growers must plant at least 20% of their total acreage to varieties without the insect resistance traits (the “refuge”) and treat the refuge acres for insects using traditional insect control methods, mostly insecticides, as appropriate. This regulation was intended to avoid or delay the build-up of insect resistance to the insecticide expressed in the traited varieties. This insecticide is bacillus Thuringiensis, or Bt, which is an approved natural insecticide for use in organic crop production. To account for the refuge requirements, the triple-stack-adopting producers' yields are only adjusted by 75% of the yield difference distinguishing triple-stack and traditional non-traited varieties. In other words, only 75% of the differential is used in making the adjustment for transgenic yields. This, of course, results in a smaller discount than would be the case if no refuge requirements existed. The 5% difference between the required refuge and the difference used to develop the rate discount allows for a degree of flexibility in measuring and implementing the refuge. However, this rating assumes that all adopters of the triple-stack varieties have planted exactly 75% of their corn acres to the triple-stack varieties. Thus in this example, rate discounts are slightly conservative in that those who adopt at 80% (the maximum allowable level given the current refuge requirement) would only receive a discount for 75% adoption.

### Discount Factors

The rating procedures described above were applied to the 2007 premium rates of the RMA. The calculations used rank correlation coefficients presented in Table 5 and the distributional properties for the yield differences outlined in FIGS. 10-12 to generate rate discounts for APH yields ranging from 75-200% of the reference yield in each of the pilot counties. Table 9 below presents a summary of the resulting rate discount factors. The discount factors represent a scaling factor which will be used to adjust existing rates (through multiplication) to obtain the new transgenic rates. The analogous discount is equal to 1 minus the factor.

TABLE 9
Summary Statistics for Rate Discount Factors

| Coverage | | | | | | | | | | |
|---|---|---|---|---|---|---|---|---|---|---|
| Level | N | Mean | Std Dev | Min | 1st %-ile | 5th %-ile | Median | 95th %-ile | 99th %-ile | Max |
| 50% | 2280 | 0.6151 | 0.1033 | 0.3481 | 0.3781 | 0.4002 | 0.6390 | 0.7420 | 0.7745 | 0.9069 |
| 55% | 2280 | 0.6811 | 0.0888 | 0.4358 | 0.4611 | 0.4892 | 0.7015 | 0.7856 | 0.8063 | 0.8824 |
| 60% | 2280 | 0.7251 | 0.0804 | 0.5040 | 0.5318 | 0.5537 | 0.7460 | 0.8190 | 0.8352 | 0.8616 |
| 65% | 2280 | 0.7597 | 0.0739 | 0.5664 | 0.5919 | 0.6102 | 0.7810 | 0.8509 | 0.8743 | 0.9103 |
| 70% | 2280 | 0.7897 | 0.0666 | 0.6264 | 0.6457 | 0.6611 | 0.8094 | 0.8765 | 0.9009 | 0.9529 |
| 75% | 2280 | 0.8139 | 0.0574 | 0.6790 | 0.6936 | 0.7077 | 0.8324 | 0.8872 | 0.9188 | 0.9709 |
| 80% | 2142 | 0.8354 | 0.0481 | 0.7206 | 0.7360 | 0.7501 | 0.8533 | 0.8927 | 0.9202 | 0.9681 |
| 85% | 2142 | 0.8555 | 0.0375 | 0.7553 | 0.7766 | 0.7889 | 0.8700 | 0.9031 | 0.9157 | 0.9597 |

The results imply average rate discount factors ranging from 0.62 (a 38% rate discount) at the 50% coverage level to 0.86 (a 14% rate discount) at the 85% coverage level. The rate discounts naturally increase as the coverage level falls. This reflects the fact that the lower yield risk of the triple-stack varieties is truncating the lower (left-hand) side tail of the yield distribution. Simply put—a farmer who adopts the new triple-stack varieties is much less likely to collect an indemnity payment on coverage of only 50% of their APH. Likewise, such payments would be much smaller than would be the case for insured traditional varieties when they do occur.

Rate discounts calculated in this example vary across individual producers' APH yields relative to the county reference yield. Table 10 presents a breakdown of the discount factors across the different APH/reference yield ratios. The discounts are largely homogeneous across different APH yield proportions at the 85% coverage level. Slight differences appear for the 75% coverage level and more prominent differences exist for the 50% coverage level. This suggests that current discount procedures (based upon the exponent system) penalize adopters of this transgenic trait more at low coverage levels.

TABLE 10
Discount Factors by Ratio of APH/Reference Yield

| APH | | | | | | | | |
|---|---|---|---|---|---|---|---|---|
| Proportion | | | | | | | | |
| of Reference | | | | | | | | |
| Yield | Mean | Std Dev | Mean | Std Dev | Mean | Std Dev | Mean | Std Dev |
| | 50% Coverage | | 55% Coverage | | 60% Coverage | | 65% Coverage | |
| 75% | 0.5713 | 0.1256 | 0.6421 | 0.1120 | 0.6964 | 0.1047 | 0.7424 | 0.0976 |
| 100% | 0.5682 | 0.1097 | 0.6387 | 0.0948 | 0.6896 | 0.0872 | 0.7312 | 0.0815 |
| 125% | 0.5914 | 0.0982 | 0.6607 | 0.0818 | 0.7074 | 0.0741 | 0.7440 | 0.0693 |
| 150% | 0.6227 | 0.0854 | 0.6889 | 0.0696 | 0.7309 | 0.0632 | 0.7627 | 0.0596 |
| 175% | 0.6539 | 0.0713 | 0.7156 | 0.0584 | 0.7528 | 0.0546 | 0.7804 | 0.0528 |
| 200% | 0.6830 | 0.0594 | 0.7406 | 0.0490 | 0.7736 | 0.0481 | 0.7976 | 0.0480 |
| | 70% Coverage | | 75% Coverage | | 80% Coverage | | 85% Coverage | |
| 75% | 0.7829 | 0.0875 | 0.8156 | 0.0746 | 0.8455 | 0.0611 | 0.8685 | 0.0453 |
| 100% | 0.7675 | 0.0743 | 0.7972 | 0.0646 | 0.8228 | 0.0546 | 0.8469 | 0.0425 |
| 125% | 0.7755 | 0.0638 | 0.8008 | 0.0558 | 0.8223 | 0.0473 | 0.8437 | 0.0376 |
| 150% | 0.7898 | 0.0553 | 0.8115 | 0.0486 | 0.8302 | 0.0410 | 0.8491 | 0.0326 |
| 175% | 0.8041 | 0.0497 | 0.8231 | 0.0439 | 0.8403 | 0.0369 | 0.8576 | 0.0291 |
| 200% | 0.8186 | 0.0460 | 0.8355 | 0.0410 | 0.8513 | 0.0343 | 0.8676 | 0.0265 |

### RMA Implementation

One embodiment of the invention includes a method for implementing discounts calculated using the methods of the invention within RMA. One implementation method, similar to that used in other RMA programs (e.g., the Revenue Assurance plan), involves the use of a fitted polynomial regression function that relates the rating factor of interest to other factors already in the Actuarial Data Master (ADM). This mechanism uses rating factors as inputs and produces an estimate of the desired rating parameter. A similar method may be used to provide a delivery mechanism for the genetically modified crop premium rate discount. Each insured may approach the insurance plan of the invention with an APH yield. The actuarial data master contains a number of factors that are used in the rating software to calculate the appropriate rate. These factors include the base premium rate, the fixed rate load, the rate relativities, the county reference yield, and the exponent.

This example used a simple quadratic regression of the transgenic discount factors for each coverage level against this collection of rating factors. In the case of only two rating factors X₁ and X₂, this would involve regressing DISC on X₁, X₂, X₁•X₂, X₁•X₁, and X₂•X₂ (where DISC denotes the discount). In this example, the following rating factors are included: the undiscounted rate, the base premium rate, the fixed rate load, the rate relativities, the county reference yield, and the exponent. This regression is estimated separately for each of the rate classes and for each coverage level. The goal of such a regression is to obtain an almost perfect fit. Correlation coefficients are obtained between the actual calculated discounts and those predicted by the regression response that are 0.995 or greater in every coverage level case. Thus, the method provides a straightforward functional relationship allowing rate discounts to be calculated from factors already present in the ADM with minimal effort. Any distortions in the very small number of cases for which the calibration of the beta produced minor inaccuracies were minimized by the fact that the regression function smoothes out differences in the discount structure across individual discounts. The function also provides a ready means for calculating continuous discounts for any particular APH yield, rate, or other rating factor. For example, although only APH rates of 75%-200% of the reference yield in 25% increments, the appropriate discount for any APH in this range (e.g., 119%, etc.) is easily calculated. This functional mechanism obviates the need for an extensive set of discontinuous rate tables, which would require interpolating across the different discrete categories. This functional mechanism is thus a straightforward mechanism for implementing the rate discount structure of the invention.

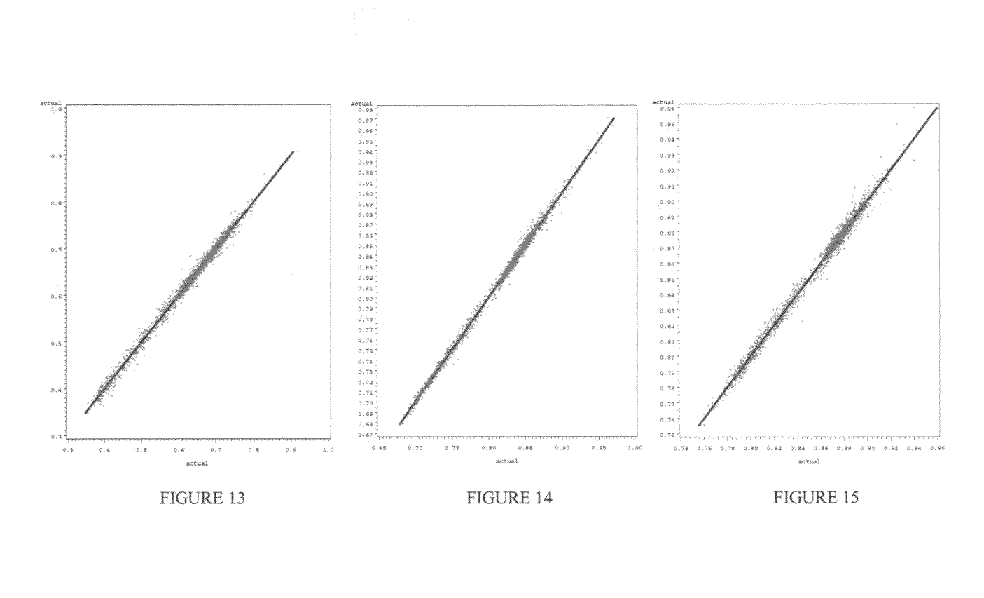

Plots of the fitted (from the regression model) and actual (calculated) discount factors are presented in FIGS. 13-15 for the 50%, 75%, and 85% coverage levels, respectively. When compared to a 45-degree line, the regression-predicted rate factors show a very high degree of consistency with the calculated factors. The parameters of the quadratic regression models may be provided to the RMA in a spreadsheet format which will allow easy implementation into the current RMA rating process and software.

While embodiments of the invention have been described relating to calculation of reduced financial risk for growing transgenic crops, and using the financial risk evaluations in calculation of transgenic crop insurance premiums, in other embodiments, the financial risk for growing transgenic crops may be used in other financial instruments. For example, crop production agreements rely on estimates of crop yields that will generally be different for transgenic crops than for their conventional counterparts. Evaluation of crop yield curves for transgenic crops (either single or stacked) for use as the basis of production agreements is thus an aspect of one embodiment of the invention. Similarly, embodiments of the invention include any financial instrument or methods that rely on yield estimates for transgenic crops. For example, ethanol processors may choose to develop and enter into a production agreement/financial instrument with corn producers designed to ensure a reliable supply of corn for their ethanol processing enterprise. In this embodiment, a processor may, because of the reduced risk associated with transgenic crops, require the corn supplier to plant corn containing transgenic traits. The present invention enables such production agreements and financial instruments by providing a method for calculating risk premiums appropriate for transgenic crops.

Finally, while the aforementioned description and example focused on calculations relating to premium reduction for transgenic crop producers, those skilled in the art will appreciate that the methods of the invention may be used to determine reduced premiums for any product or activity that reduces risk. The aforementioned description and example thus do not limit the scope of the invention, but instead illustrate a particular application.

1. A method for calculating a rate for a transgenic crop insurance policy purchased by a crop producer, wherein the transgenic crop comprises at least one trait as a result of having at least one transgene, the method comprising the steps of:
calculating a first risk premium associated with a conventional, non-transgenic crop based upon the actual production history yields of the conventional, non-transgenic crop;
growing the transgenic crop and determining the yield of the transgenic crop to generate yield data for the transgenic crop;
comparing the yield data for the transgenic crop to yield data for the conventional, non-transgenic crops to create a risk correlation based on (1) the difference between the yield data for the transgenic crop and the yield data for the conventional, non-transgenic crop, correlated with (2) the yield data for the non-transgenic crop;
simulating a yield distribution for the difference in yield performance between the transgenic and the non-transgenic crop using the risk correlation;
simulating a yield distribution for the conventional, non-transgenic crop using existing crop insurance rates;
creating a yield distribution for the transgenic crop based on (a) the risk correlation, (b) the simulated yield distribution for the difference in yield distribution for the difference in yield performance between the transgenic and the non-transgenic crop, and (c) the yield distribution for the conventional, non-transgenic crop; and
calculating the rate for the transgenic crop insurance policy based on the yield distribution for the transgenic crop.

2. The method of claim 1, further comprising the step of incorporating the rate for the transgenic crop insurance policy into a ratio with the rate for a conventional, non-transgenic crop insurance policy to produce a discount factor.

3. The method of claim 2, further comprising the step of applying the discount factor to the first risk premium to calculate a second risk premium for a transgenic crop.

4. The method of claim 3, further comprising the step of incorporating the discount factor into an existing RMA crop insurance rating system.

5. The method of claim 1, further comprising the step of using the risk correlation to measure an effectiveness of a transgenic trait, a non-transgenic crop trait, or a combination of transgenic and non-transgenic crop traits to mitigate abiotic or biotic stresses.

6. The method of claim 3, wherein the steps of calculating the first and second risk premiums include measuring crop yield distributions and using crop analytics or remotely-sensing methodology to determine crop composition, predict yield, or estimate risk.

7. The method of claim 1, wherein the trait is selected from the group consisting of drought resistance, water logged soil tolerance, salt tolerance, disease resistance, herbicide tolerance, tolerance to herbicide-resistant weeds, insect resistance, efficient nitrogen use, cold stress tolerance, heat stress tolerance, increased oil production, increased protein production, unique oil and protein production, increased fermentable starch production, increased content of essential amino acids, increased content of fatty acids, increased yield, and yield stability.

8. The method of claim 7, wherein the transgenic crop is selected from the group consisting of corn, soybean, cotton, rice, wheat, canola, vegetable crops, forest tree crops, forage crops, and cellulosic ethanol feedstocks.

9. The method of claim 3, further comprising the step of determining the difference between the first risk premium and the second risk premium to produce a difference risk premium.

10. The method of claim 9, wherein the crop producer purchases transgenic crop seeds for a price that is greater than the price of the conventional, non-transgenic crop seeds for the same crop by an amount that is equal to or greater than the difference risk premium.

11. The method of claim 9, wherein the crop producer pays the difference risk premium for the transgenic crop seeds only if the risk management benefits of the trait are realized.

12. The method of claim 9, wherein the crop producer purchases transgenic crop seeds for a price that includes a difference in the risk premium.

13. The method of claim 1, wherein the transgenic crop has two or more stacked traits.

14. A financial instrument comprising a transgenic crop insurance policy, wherein the price of the transgenic crop insurance policy is reduced relative to a conventional non-transgenic crop insurance policy for the same type of crop by an amount corresponding to a value measured as the cost of the difference between: (a) a risk premium associated with a conventional, non-transgenic crop based upon the actual production history yields of the conventional, non-transgenic crop, and (b) a risk premium associated with a transgenic crop based upon measured yield distributions or the actual production history yields of the transgenic crop, wherein the transgenic crop exhibits at least one trait as a result of having at least one transgene.

15. A production agreement for a transgenic crop wherein the production agreement is based upon a calculation of a risk premium associated with a transgenic crop based upon measured yield distributions, simulated yield distributions, or the actual production history yields of the transgenic crop.

16. A method for determining an insurance premium rate for a transgenic crop comprising the steps of:
determining an expected yield for the transgenic crop;
fitting a probability distribution function to a rating structure for a traditional crop using the expected yield;
simulating a yield distribution for the transgenic crop; and
estimating the premium rate for the transgenic crop based on the simulated yield distribution.

17. The method of claim 16, further comprising the step of gathering yield data from side-by-side field trials of the transgenic and traditional crops, and determining yield differences between the transgenic crop and the traditional crop from the yield data.

18. The method of claim 17, wherein the probability distribution function is a beta probability distribution function.

19. The method of claim 18, wherein the step of simulating a yield distribution for the transgenic crop comprises drawing correlated random variables from the beta distribution for the rating structure for the traditional crop and an estimated distribution of the yield differences between the transgenic crop and the traditional crop.

20. The method of claim 19, wherein the trait is selected from the group consisting of drought resistance, water logged soil tolerance, salt tolerance, disease resistance, herbicide tolerance, tolerance to herbicide resistant weeds, insect resistance, efficient nitrogen use, cold stress tolerance, heat stress tolerance, increased oil production, increased protein production, unique oil and protein production, increased fermentable starch production, increased content of essential amino acids, increased yield, and yield stability.

21. The method of claim 19, wherein the transgenic crop is selected from the group consisting of corn, soybean, cotton, rice, wheat, canola, vegetable crops, forest tree crops, forage crops, and cellulosic ethanol feedstocks.

22. The method of claim 19, wherein the crop producer purchases transgenic crop seeds for a price that is greater than the price of the conventional, non-transgenic crop seeds for the same crop by an amount that is equal to the difference risk premium.

23. The method of claim 19, wherein the crop producer pays the difference risk premium for the transgenic crop seeds only if the risk management benefits of the trait are realized.

24. The method of claim 19, wherein the crop producer purchases transgenic crop seeds for a price that includes a difference in the risk premium.

25. The method of claim 24, wherein the price is less than the difference in the risk premium.

26. The method of claim 20, wherein the transgenic crop has two or more stacked traits.
